(19) United States
(12) Patent Application Publication
(10) Pub. No.: US 2023/0029237 A1
(43) Pub. Date: Jan. 26, 2023

(54) ELECTROLYSIS ELEMENT FOR ALKALINE WATER ELECTROLYSIS, AND ALKALINE WATER ELECTROLYSIS VESSEL

(71) Applicant: TOKUYAMA CORPORATION, Shunan-shi, Yamaguchi (JP)

(72) Inventors: Yasuyuki TANAKA, Shunan-shi (JP); Hitoshi MATSUI, Shunan-shi (JP)

(73) Assignee: TOKUYAMA CORPORATION, Shunan-shi, Yamaguchi (JP)

(21) Appl. No.: 17/801,884

(22) PCT Filed: Mar. 23, 2021
(86) PCT No.: PCT/JP2021/011894

§ 371 Date: Aug. 24, 2022

(30) Foreign Application Priority Data
Mar. 31, 2020 (JP) 2020-064942

(51) Int. Cl. C25B 1/04; C25B 9/21; C25B 9/65; C25B 13/02; C25B 15/04

(52) U.S. Cl. CPC C25B 1/04; C25B 9/21; C25B 9/65; C25B 13/02; C25B 15/04

(57) ABSTRACT

An electrolysis element for alkaline water electrolysis includes: an electroconductive separating wall including a first face and a second face; an anode for generating oxygen; a cathode for generating hydrogen; a first connecting means fixing the anode to the separating wall such that the anode faces the first face of the separating wall at a first distance, and electrically connecting the anode to the separating wall; an electroconductive elastic body supporting the cathode; and a cathode current collector supporting the elastic body, the cathode current collector being fixed to the separating wall, to face the second face of the separating wall at a second distance, and being electrically connected to the separating wall, the first connecting means including: an electroconductive bolt including at least a shaft, wherein the anode is removably fixed to the separating wall by means of the electroconductive bolt.

### TECHNICAL FIELD

The present invention relates to an electrolysis element and an electrolysis vessel, and more specifically, to an electrolysis element and an electrolysis vessel which can be preferably used for alkaline water electrolysis.

### BACKGROUND ART

The alkaline water electrolysis method is known as a method of producing hydrogen gas and oxygen gas. In the alkaline water electrolysis method, hydrogen gas is generated at a cathode and oxygen gas is generated at an anode by electrolyzing water with a basic solution (alkaline water) where an alkali metal hydroxide (such as NaOH and KOH) dissolves, used as an electrolytic solution. An electrolysis vessel including an anode chamber where an anode is disposed and a cathode chamber where a cathode is disposed which are separated by an ion-permeable separating membrane is known as an electrolysis vessel for alkaline water electrolysis. Further, for reducing energy loss, an electrolysis vessel having a zero-gap configuration (zero-gap electrolysis vessel) which includes an anode and a cathode held in such a manner that the anode and the cathode are in direct contact with a separating membrane is proposed.

### CITATION LIST

### Patent Literature

Patent Literature 1: JP 2001-262387 A
Patent Literature 2: JP 2013-104090 A
Patent Literature 3: JP 2013-108150 A
Patent Literature 4: WO 2018/139616 A1
Patent Literature 5: JP 2015-117407 A
Patent Literature 6: WO 2013/191140 A1
Patent Literature 7: JP 4453973 B2
Patent Literature 8: JP 6093351 B2
Patent Literature 9: JP 2015-117417 A
Patent Literature 10: WO 2019/111832 A1
Patent Literature 11: JP S56-102586 A

### SUMMARY OF INVENTION

### Technical Problem

FIG. 1 is a partial cross-sectional view schematically illustrating a conventional zero-gap alkaline water electrolysis vessel 9000 according to one embodiment. The zero-gap electrolysis vessel 9000 comprises: electrode chamber units 9010, 9010, . . . each including an electroconductive separating wall 9011 that separates an anode chamber A and a cathode chamber C, and a flange portion 9012. Every two adjacent electrode chamber units 9010, 9010 comprise an ion-permeable separating membrane 9020 arranged therebetween; gaskets 9030, 9030 which are arranged between the separating membrane 9020 and the flange portions 9012 of the electrode chamber units 9010, and between which the periphery of the separating membrane 9020 is sandwiched; a rigid anode 9040 held by electroconductive ribs 9013, 9013, . . . that protrude from the separating wall 9011 of one of the electrode chamber units; and a flexible cathode 9070 held by a current collector 9050 that is held by electroconductive ribs 9014, 9014, . . . that protrude from the separating wall 9011 of the other electrode chamber unit, and an electroconductive elastic body 9060 that is arranged in contact with the current collector 9050. The periphery of the cathode 9070 and the periphery of the electroconductive elastic body 9060 are fixed to the periphery of the current collector 9050. In the zero-gap electrolysis vessel 9000, in every two adjacent electrode chamber units 9010, 9010, the electroconductive elastic body 9060 pushes the flexible cathode 9070 toward the separating membrane 9020 and the anode 9040, whereby the separating membrane 9020 is sandwiched between the adjacent cathode 9070 and anode 9040. As a result, in every two adjacent electrode chamber units 9010, 9010, the separating membrane 9020 is in direct contact with the anode 9040 and the cathode 9070 (that is, there is a zero-gap), which reduces the solution resistance between the anode 9040 and the cathode 9070, and thus reduces energy loss.

In the conventional zero-gap alkaline water electrolysis vessel 9000, the electroconductive elastic bodies 9060 push the flexible cathodes 9070 toward the separating membranes 9020 and the rigid anodes 9040, the rigid anodes 9040 are welded to the electroconductive ribs 9013, and the electroconductive ribs 9013 are welded to the separating walls 9011. This structure can be said to be reasonable in the process of alkaline water electrolysis in which it is often the case that the pressure on the cathode chamber side where hydrogen gas is generated is kept higher than that on the anode chamber side where oxygen gas is generated. That is, generally, an inexpensive porous membrane is used as the ion-permeable separating membrane 9020 in an alkaline water electrolysis vessel instead of an expensive ion-exchange membrane that is used in an electrolysis vessel for alkali metal salts. The porous separating membrane 9020 also has, unlike an ion-exchange membrane, gas permeability in some degree. Because of this, it is advantageous to carry out electrolysis with the cathode chamber, where hydrogen gas is generated, and where the pressure therein is kept higher than that in the anode chamber, where oxygen gas is generated, in view of improving the purity of hydrogen gas collected from the cathode chamber. When the pressure in the cathode chamber is higher than that in the anode chamber, the separating membrane 9020 is pushed toward the anode 9040 by the differential pressure between both the electrode chambers. In such a structure that the electroconductive elastic body 9060 pushes the flexible cathode 9070 toward the rigid anode 9040 as in the alkaline water electrolysis vessel 9000, the direction where the electroconductive elastic body 9060 pushes the cathode 9070 is the same as that of the force by which the differential pressure between both the electrode chambers pushes the separating membrane 9020. Thus, such a structure allows a zero-gap state to be stably maintained even when the resilience of the electroconductive elastic body 9060 is low. This can be also said to be advantageous in view of lengthening the intervals for the renewal of the elastic body 9060, and in view of reducing abrasion of the separating membrane 9020 which is caused by a pressure fluctuation during the operation. It can be also said to be advantageous to weld and fix the electroconductive ribs 9013 holding the anode 9040 to the separating wall 9011 in view of improving mechanical strength, and in view of reducing electrical resistance.

However, oxygen gas is generated at the anode 9040 in the alkaline water electrolysis vessel, which, in combination with the fact that electrons flow out of the anode 9040, puts the anode 9040 under an oxidative condition. The anode 9040 generally includes an electroconductive base material, and a catalyst supported on the surface of this base material. Catalysts and electroconductive base materials tend to ionize or oxidize at the anode 9040 put under an oxidative condition as described above, which makes the catalyst easy to fall off the surface of the electrode. As a result, the anode 9040 tends to reach its life span sooner than the cathode 9070. The anode 9040 having reached its life span is necessary to be replaced with a new anode. For this, it is necessary to (1) separate the anode 9040 from the electroconductive ribs 9013 mechanically (for example, by melt-cutting), (2) adjust the electroconductive ribs 9013 and make the electroconductive ribs 9013 the same height at their ends (for example, by grinding), and thereafter (3) welding the new anode 9040 to the electroconductive ribs 9013. It is difficult to carry out the work of replacing the anode 9040 at a site where the electrolysis vessel is placed and operated because facilities especially for such a replacement work are necessary. Thus, the electrode chamber unit 9010 that includes the anode 9040 having reached its life span is sent to a factory where the work of replacing the anode 9040 can be carried out; and after the work of replacing the anode 9040 has been carried out at this factory, the electrode chamber unit 9010 after the work of replacing the anode 9040 has been finished is sent back from the factory to the site where the electrolysis vessel is placed and operated. Like this, the work of renewing the anode for the conventional zero-gap alkaline water electrolysis vessel costs a lot.

An object of the present invention is to provide an electrolysis element for alkaline water electrolysis which can be used for a zero-gap alkaline water electrolysis vessel, and which allows easy replacement of anodes. An alkaline water electrolysis vessel comprising this electrolysis element is also provided.

### Solution to Problem

The present invention encompasses the following embodiments [1] to [25].

[1] An electrolysis element for alkaline water electrolysis, the electrolysis element comprising:

an electroconductive separating wall comprising a first face and a second face;

an anode for generating oxygen;

a cathode for generating hydrogen;

a first connecting means fixing the anode to the separating wall such that the anode faces the first face of the separating wall at a first distance, and electrically connecting the anode to the separating wall;

an electroconductive elastic body supporting the cathode; and

a cathode current collector supporting the elastic body,

the cathode current collector being fixed to the separating wall, to face the second face of the separating wall at a second distance, and being electrically connected to the separating wall,

the first connecting means comprising:
an electroconductive first bolt comprising at least a shaft,

wherein the anode is removably fixed to the separating wall by means of the first bolt.

[2] The electrolysis element according to [1],

the first connecting means further comprising:
a first through-hole provided in the separating wall, wherein the shaft of the first bolt can be put through the first through-hole; and
a first nut which can engage with the first bolt.

[3] The electrolysis element according to [2],

the first connecting means further comprising:
an electroconductive first structural element,

the first structural element comprising:
a first spacer portion extending from the anode toward the first face of the separating wall in a direction crossing the first face of the separating wall; and
a first plate-shaped portion being continuous from the first spacer portion and extending in a direction parallel to the first face of the separating wall,

the first spacer portion comprising:
an end fixed to the anode,

the first plate-shaped portion comprising:
a second through-hole, wherein the shaft of the first bolt can be put through the second through hole,

wherein the shaft of the first bolt is put through the first through-hole and the second through-hole and engages with the first nut, to fix the first structural element to the separating wall.

[4] The electrolysis element according to [3],

wherein the second through-hole is continuous from the first plate-shaped portion to at least part of the first spacer portion.

[5] The electrolysis element according to [3] or [4],

the first bolt further comprising:
a head arranged at an end of the shaft,

the shaft of the first bolt being put through the first through-hole and the second through-hole, in a direction such that the head of the first bolt pushes the first plate-shaped portion of the first structural element toward the separating wall,

the first structural element further comprising:
a rotation-limiting portion, wherein when the shaft of the first bolt is put through the second through-hole and the head of the first bolt contacts with the first plate-shaped portion, the rotation-limiting portion contacts with a side surface of the head of the first bolt, to limit rotation of the first bolt.

[6] The electrolysis element according to any one of [3] to [5],

the first connecting means further comprising:
a second nut which can engage with the first bolt,

wherein the second nut engages with the shaft of the first bolt put through the second through-hole, such that the head of the first bolt and the second nut sandwich the first plate-shaped portion of the first structural element, to fix the first bolt to the first plate-shaped portion of the first structural element; and

the shaft of the first bolt fixed to the first plate-shaped portion of the first structural element is put through the first through-hole of the separating wall and engages with the first nut, to fix the first bolt to the separating wall.

[7] The electrolysis element according to any one of [3] to [6],

the cathode current collector comprising:
a third through-hole provided in a position facing the first through-hole of the separating wall, the third through-hole having a shape and dimensions such that the first nut can pass through the third through-hole.

[8] The electrolysis element according to [7], further comprising:

an electroconductive and removable first lid member covering at least part of the third through-hole of the cathode current collector,

wherein when the first lid member is put to cover at least part of the third through-hole of the cathode current collector, the first lid member is electrically connected to the cathode current collector.

[9] The electrolysis element according to [1],

the first connecting means further comprising:
a first threaded hole opening in the first face of the separating wall, wherein the first threaded hole can engage with the first bolt.

[10] The electrolysis element according to [9],

the first connecting means further comprising:
an electroconductive first structural element,

the first structural element comprising:
a first spacer portion extending from the anode toward the first face of the separating wall in a direction crossing the first face of the separating wall; and
a first plate-shaped portion being continuous from the first spacer portion and extending in a direction parallel to the first face of the separating wall,

the first spacer portion comprising:
an end fixed to the anode,

the first plate-shaped portion comprising:
a second through-hole, wherein the shaft of the first bolt can be put through the second through-hole,

wherein the shaft of the first bolt is put through the second through-hole and engages with the first threaded hole of the separating wall, to fix the first structural element to the separating wall.

[11] The electrolysis element according to [10],

the anode comprising:
a fourth through-hole provided in a position facing the second through-hole, the fourth through-hole having a shape and dimensions such that the first bolt can pass through the fourth through-hole.

[12] The electrolysis element according to [11], further comprising:

a second lid member comprising a same material as the anode and covering at least part of the fourth through-hole of the anode; and

an electroconductive second bolt fixed to the second lid member,

the first bolt further comprising a head,

the head of the first bolt comprising:
a second threaded hole which can engage with the second bolt,

wherein the second bolt engages with the second threaded hole, such that the second lid member is removably fixed to the first bolt and is electrically connected to the first bolt and such that the second lid member covers at least part of the fourth through-hole of the anode.

[13] The electrolysis element according to [9],

the first bolt being a stud bolt,

the stud bolt comprising:
a first end; and
a second end,

the first connecting means further comprising:
an electroconductive first structural element; and
a first nut which can engage with the stud bolt,

the first structural element comprising:
a first spacer portion extending from the anode toward the first face of the separating wall in a direction crossing the first face of the separating wall; and
a first plate-shaped portion being continuous from the first spacer portion and extending in a direction parallel to the first face of the separating wall,

the first spacer portion comprising:
an end fixed to the anode,

the first plate-shaped portion comprising:
a second thorough-hole, wherein the first bolt can be put through the second through-hole,

wherein the stud bolt engages with the first threaded hole of the separating wall, to fix the first end of the stud bolt to the separating wall; and

the stud bolt fixed to the separating wall is put through the second through-hole, and the first nut engages with the stud bolt from the second end of the stud bolt, to fix the first structural element to the separating wall.

[14] The electrolysis element according to [13],

the anode comprising:
a fourth through-hole provided in a position facing the second through-hole, the fourth through-hole having a shape and dimensions such that the first nut can pass through the fourth through-hole.

[15] The electrolysis element according to [14], further comprising:

a second lid member comprising a same material as the anode and covering at least part of the fourth through-hole of the anode; and

an electroconductive second bolt fixed to the second lid member,

the second end of the stud bolt comprising:
a second threaded hole which can engage with the second bolt,

wherein the second bolt engages with the second threaded hole, such that the second lid member is removably fixed to the stud bolt and is electrically connected to the stud bolt, and such that the second lid member covers at least part of the fourth through-hole of the anode.

[16] The electrolysis element according to any one of [1] to [15], further comprising:

a second connecting means fixing the cathode current collector to the separating wall such that the cathode current collector faces the second face of the separating wall at the second distance, and electrically connecting the cathode current collector to the separating wall,

the second connecting means comprising:
an electroconductive second structural element,

the second structural element comprising:
a second spacer portion extending between the cathode current collector and the second face of the separating wall in a direction crossing the second face of the separating wall;
a first end fixed to the cathode current collector; and
a second end fixed to the second face of the separating wall.

[17] An electrolysis element for alkaline water electrolysis, the electrolysis element comprising:

a separating wall comprising a first face and a second face;

an anode for generating oxygen;

a cathode for generating hydrogen;

an electroconductive elastic body supporting the cathode;

a cathode current collector supporting the elastic body; and

a third connecting means fixing the anode and the cathode current collector to the separating wall and electrically connecting the anode and the cathode current collector, such that the anode faces the first face of the separating wall and the cathode current collector faces the second face of the separating wall,

the third connecting means comprising:
an electroconductive first bolt comprising at least a shaft;
a first through-hole provided in the separating wall, wherein the shaft of the first bolt can put through the first through-hole; and
a first nut which can engage with the first bolt,

the anode comprising:
a first flat portion extending two-dimensionally;
a first cup-shaped portion protruding from the first flat portion toward the first face of the separating wall and being tapered; and
a fifth through-hole provided in a bottom portion of the first cup-shaped portion, wherein the shaft of the first bolt can be put through the fifth through-hole,

the cathode current collector comprising:
a second flat portion extending two-dimensionally;
a second cup-shaped portion protruding from the second flat portion toward the second face of the separating wall and being tapered;
a sixth through-hole provided in a bottom portion of the second cup-shaped portion, wherein the shaft of the first bolt can be put through the sixth through-hole,

wherein the shaft of the first bolt is put through the first through hole, the fifth through-hole, and the sixth through-hole, and engages with the first nut, to fix the anode and the cathode current collector to the separating wall by means of the first bolt.

[18] The electrolysis element according to [17],

the first bolt further comprising:
a head arranged at an end of the shaft,

wherein the head of the first bolt and the first nut sandwich and fasten the anode, the separating wall, and the cathode current collector.

[19] The electrolysis element according to [18], further comprising:

a second lid member comprising a same material as the anode, and having a shape extending two-dimensionally such that the second lid member can cover at least part of an opening of the first cup-shaped portion of the anode; and

an electroconductive second bolt,

the second bolt comprising:
a head fixed to the second lid member; and
a shaft fixed to the head,

the head of the first bolt comprising:
a threaded hole which can engage with the second bolt,

wherein the second bolt engages with the threaded hole, such that the second lid member is removably fixed to the first bolt and is electrically connected to the first bolt and covers at least part of the opening of the first cup-shaped portion of the anode.

[20] The electrolysis element according to [17], further comprising:

a second lid member comprising a same material as the anode and having a shape extending two-dimensionally such that the second lid member can cover at least part of an opening of the first cup-shaped portion of the anode,

the first bolt further comprising:
a head arranged at an end of the shaft,

the second lid member being fixed to the head of the first bolt and being electrically connected to the first bolt,

the third connecting means further comprising:
a second nut which can engage with the first bolt,

wherein the shaft of the first bolt is put through the first through-hole, the fifth through-hole, and the sixth through-hole, and engages with the first nut and the second nut, such that the first nut and the second nut sandwich and fasten the anode, the separating wall, and the cathode current collector, and such that the anode, the second lid member, and the cathode current collector are removably fixed to the separating wall by means of the first bolt, and such that the second lid member covers at least part of the opening of the first cup-shaped part of the anode.

[21] The electrolysis element according to any one of [1] to [20], further comprising:
a flange portion being arranged at a periphery of the separating wall and extending toward both sides of the separating wall in a direction crossing the first face and the second face of the separating wall.

[22] An alkaline water electrolysis vessel comprising a stack structure,

the stack structure comprising:
a plurality of ion-permeable separating membrane;
the electrolysis element as defined in any one of [1] to [21], arranged between each adjacent pair of the ion-permeable separating membranes,

wherein each adjacent pair of the electrolysis elements is arranged so that the anode of a first one of the electrolysis elements of the pair and the cathode of a second one of the electrolysis elements of the pair face each other sandwiching the ion-permeable separating membrane therebetween.

[23] The alkaline water electrolysis vessel according to [22],

the stack structure comprising:
a first electrolysis element arranged at a first end of the stack structure; and
a second electrolysis element arranged at a second end of the stack structure,

the electrolysis vessel further comprising:
a first terminal element arranged facing the cathode of the first electrolysis element, such that the first terminal element and the cathode of the first electrolysis element sandwich a first one of the ion-permeable separating membranes therebetween;
a second terminal element arranged facing the anode of the second electrolysis element, such that the second terminal element and the anode of the second electrolysis element sandwich a second one of the ion-permeable separating membranes therebetween,

the first terminal element comprising:
an electroconductive first separating wall; and
a first anode electrically connected to the first separating wall,

the second terminal element comprising:
an electroconductive second separating wall; and
a second cathode electrically connected to the second separating wall.

[24] The alkaline water electrolysis vessel according to [22], further comprising:

gaskets each holding each periphery of the ion-permeable separating membranes;

insulating frame-shaped protecting members each holding each periphery of the ion-permeable separating membranes, the gasket being present between the protecting member and the separating membrane; and

sealing members arranged between the separating wall and the protecting member, between the first separating wall and the protecting member, and between the second separating wall and the protecting member,

wherein each of the electrolysis elements is the electrolysis element as defined in any one of [1] to [20].

[25] The alkaline water electrolysis vessel according to [23],

each of the electrolysis elements being the electrolysis element as defined in [21],

the first terminal element further comprising:
a first flange portion being arranged at a periphery of the first separating wall and extending toward the flange portion of the first electrolysis element,

the second terminal element further comprising:
a second flange portion being arranged at a periphery of the second separating wall and extending toward the flange portion of the second electrolysis element.

### Advantageous Effects of Invention

The electrolysis element for alkaline water electrolysis according to the first aspect of the present invention allows easy replacement of the anode by removably fixing the anode to the separating wall by means of the electroconductive bolt, and thus can reduce time and cost required for renewal of the anode.

The alkaline water electrolysis vessel according to the second aspect of the present invention comprises the electrolysis element according to the first aspect of the present invention, and thereby, allows easy replacement of anodes; thus can reduce time and cost required for renewal of the anode.

### BRIEF DESCRIPTION OF DRAWINGS

FIG. 1 is a partial cross-sectional view schematically illustrating the conventional zero-gap electrolysis vessel 9000 according to one embodiment;

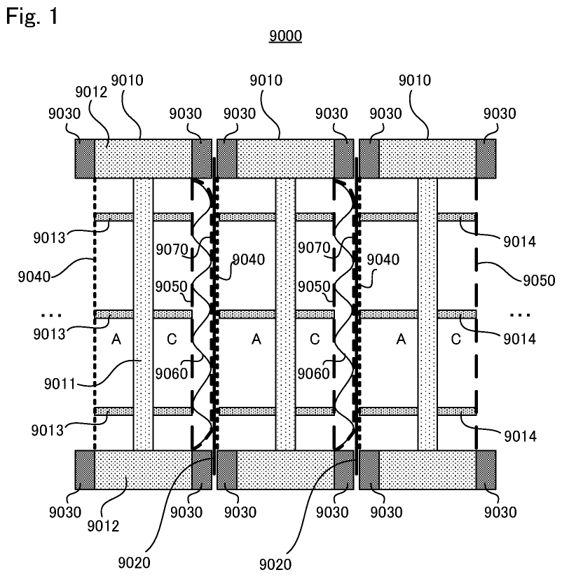

FIG. 2A is a cross-sectional view schematically illustrating an electrolysis element 100 according to one embodiment of the present invention; and FIG. 2B is an exploded cross-sectional view schematically illustrating a position of the electrolysis element 100 in FIG. 2A, which is exploded;

FIG. 3 is a perspective view schematically illustrating a first structural element 43;

FIG. 4A is a cross-sectional view schematically illustrating an electrolysis element 200 according to another embodiment of the present invention; and FIG. 4B is an exploded cross-sectional view schematically illustrating a position of the electrolysis element 200 in FIG. 4A, which is exploded;

FIG. 5A is a plan view of a cathode current collector 60; FIG. 5B is a plan view showing a position of first lid members 61, 61, . . . put in third through-holes 60h, 60h, . . . of the cathode current collector 60 in FIG. 5A; and FIG. 5C shows FIG. 5B viewed in the direction indicated by the arrow C-C;

FIG. 6A is a plan view schematically illustrating the first lid member 61; and FIG. 6B is a front view of FIG. 6A which also serves as right and left side views thereof;

FIG. 7A is a cross-sectional view schematically illustrating an electrolysis element 300 according to another embodiment of the present invention; and FIG. 7B is an exploded cross-sectional view schematically illustrating a position of the electrolysis element 300 in FIG. 7A, which is exploded;

FIG. 8A is a cross-sectional view schematically illustrating an electrolysis element 400 according to another embodiment of the present invention; and FIG. 8B is an exploded cross-sectional view schematically illustrating a position of the electrolysis element 400 in FIG. 8A, which is exploded;

FIG. 9A is a perspective view schematically illustrating a first structural element 443; FIG. 9B is a plan view of one example of the position where a shaft 41a of a first bolt 41 is put through a second through-hole 43bh of the first structural element 443 of FIG. 9A which is viewed from the upper side of the sheet of FIG. 9A; and FIG. 9C is a plan view of another example of the position where the shaft 41a of the first bolt 41 is put through the second through-hole 43bh of the first structural element 443 of FIG. 9A which is viewed from the upper side of the sheet of FIG. 9A;

FIG. 10A is a perspective view schematically illustrating a first structural element 443′ according to another embodiment; and FIG. 10B is a plan view of a position where the shaft 41a of the first bolt 41 is put through the second through-hole 43bh of the first structural element 443′ of FIG. 10A which is viewed from the upper side of the sheet of FIG. 10A;

FIG. 11A is a perspective view schematically illustrating a first structural element 443″ according to another embodiment; and FIG. 11B is a plan view of a position where the shaft 41a of the first bolt 41 is put through the second through-hole 43bh of the first structural element 443″ of FIG. 11A which is viewed from the upper side of the sheet of FIG. 11A;

FIG. 12A is a cross-sectional view schematically illustrating an electrolysis element 500 according to another embodiment of the present invention; and FIG. 12B is an exploded cross-sectional view schematically illustrating a position of the electrolysis element 500 in FIG. 12A, which is exploded;

FIG. 13A is a perspective view schematically illustrating a first structural element 443′″ according to another embodiment; and FIG. 13B is a plan view of an example of the position where the shaft 41a of the first bolt 41 is put through a second through-hole 443′″bh of the first structural element 443′″ of FIG. 13A which is viewed from the upper side of the sheet of FIG. 13A;

FIG. 14A is a cross-sectional view schematically illustrating an electrolysis element 600 according to another embodiment of the present invention; and FIG. 14B is an exploded cross-sectional view schematically illustrating a position of the electrolysis element 600 in FIG. 14A, which is exploded;

FIG. 15A is a cross-sectional view schematically illustrating an electrolysis element 700 according to another embodiment of the present invention; and FIG. 15B is an exploded cross-sectional view schematically illustrating a position of the electrolysis element 700 in FIG. 15A, which is exploded;

FIG. 16A is a cross-sectional view schematically illustrating an electrolysis element 800 according to another embodiment of the present invention; and FIG. 16B is an exploded cross-sectional view schematically illustrating a position of the electrolysis element 800 in FIG. 16A, which is exploded;

FIG. 17A is a cross-sectional view schematically illustrating an electrolysis element 900 according to another embodiment of the present invention; and FIG. 17B is an exploded cross-sectional view schematically illustrating a position of the electrolysis element 900 in FIG. 17A, which is exploded;

FIG. 18A is a plan view schematically illustrating an anode 920; and FIG. 18B is a cross-sectional view taken along the line B-B in FIG. 18A;

FIG. 19A is a plan view schematically illustrating a cathode current collector 960; and FIG. 19B is a cross-sectional view taken along the line B-B in FIG. 19A;

FIG. 20A is a cross-sectional view schematically illustrating an electrolysis element 1000 according to another embodiment of the present invention; and FIG. 20B is an exploded cross-sectional view schematically illustrating a position of the electrolysis element 1000 in FIG. 20A, which is exploded;

FIG. 21A is a cross-sectional view schematically illustrating an electrolysis element 1100 according to another embodiment of the present invention; and FIG. 21B is an exploded cross-sectional view schematically illustrating a position of the electrolysis element 1100 in FIG. 21A, which is exploded;

FIG. 22A is a cross-sectional view schematically illustrating an electrolysis element 1200 according to another embodiment of the present invention; and FIG. 22B is an exploded cross-sectional view schematically illustrating a position of the electrolysis element 1200 in FIG. 22A, which is exploded;

FIG. 23 is a cross-sectional view schematically illustrating an alkaline water electrolysis vessel 10000 according to one embodiment of the present invention;

FIG. 24 is an exploded view of FIG. 23;

FIG. 25A is a plan view schematically illustrating a protecting member 110 holding a separating membrane 80 and a gasket 90; FIG. 25B is a cross-sectional view in the direction indicated by the arrow B-B of FIG. 25A; FIG. 25C is a cross-sectional view showing a position of the protecting member 110 in FIG. 25B, which is exploded; and FIG. 25D is a cross-sectional view showing a position of the protecting member 110 in FIG. 25B, which is exploded;

FIG. 26A is a cross-sectional view schematically illustrating a first terminal element 1300; and FIG. 26B is an exploded cross-sectional view schematically illustrating a position of the first terminal element 1300 in FIG. 26A, which is exploded;

FIG. 27A is a cross-sectional view schematically illustrating a first terminal element 1300′ according to another embodiment; and FIG. 27B is an exploded cross-sectional view schematically illustrating a position of the first terminal element 1300′ in FIG. 27A, which is exploded;

FIG. 28 is a cross-sectional view schematically illustrating an alkaline water electrolysis vessel 20000 according to another embodiment of the present invention;

FIG. 29 is an exploded view of FIG. 28;

FIG. 30A is a cross-sectional view schematically illustrating a first terminal element 21300; and FIG. 30B is an exploded cross-sectional view schematically illustrating a position of the first terminal element 21300 in FIG. 30A, which is exploded; and

FIG. 31A is a cross-sectional view schematically illustrating a second terminal element 21400; and FIG. 31B is an exploded cross-sectional view schematically illustrating a position of the second terminal element 21400 in FIG. 31A, which is exploded.

### DESCRIPTION OF EMBODIMENTS

Hereinafter embodiments according to the present invention will be described with reference to the drawings. The present invention is not limited to these embodiments. The dimensions in the drawings do not always represent exact dimensions. Some reference signs may be omitted in the drawings. In the present description, the expression “A to B” concerning numeral values A and B shall mean “no less than A and no more than B” unless otherwise specified. In such an expression, if a unit is added only to the numeral value B, this unit shall be applied to the numeral value A as well. A word “or” shall mean a logical sum unless otherwise specified. The expression “E1 and/or E2” concerning elements E1 and E2 shall mean “E1, or E2, or the combination thereof”; and the expression “E1, . . . , EN-1, and/or EN” concerning elements E1, . . . , EN (N is an integer of 3 or more) shall mean “E1, . . . , EN-1, or EN, or any combination thereof”.

<1. Electrolysis Element>

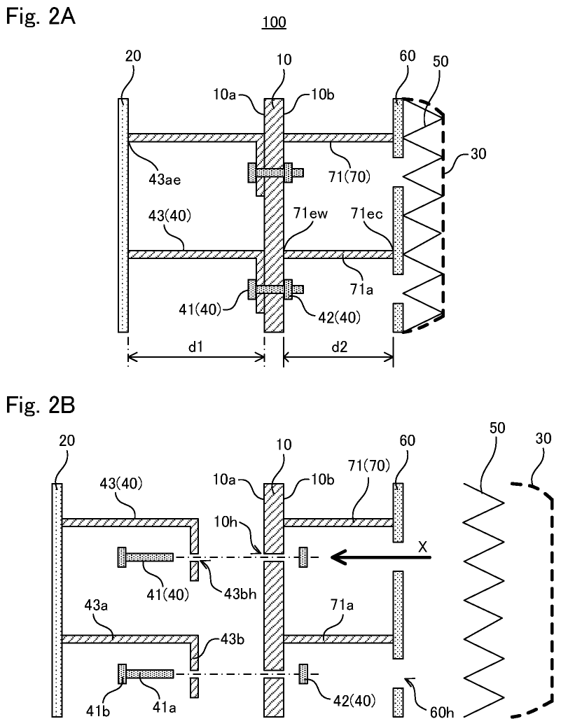

FIG. 2A is a cross-sectional view schematically illustrating an electrolysis element 100 for alkaline water electrolysis according to one embodiment (hereinafter may be referred to as “electrolysis element 100”). As shown in FIGS. 2A and 2B, the electrolysis element 100 comprises: an electroconductive separating wall 10 comprising a first face 10a and a second face 10b; an anode 20 for generating oxygen; a cathode 30 for generating hydrogen; a first connecting means 40 fixing the anode 20 to the separating wall 10 such that the anode 20 faces the first face 10a of the separating wall 10 at a first distance d1, and electrically connecting the anode 20 to the separating wall 10; an electroconductive elastic body 50 supporting the cathode 30; and a cathode current collector 60 supporting the elastic body 50. The cathode current collector 60 is fixed to the separating wall 10, to face the second face 20b of the separating wall at a second distance d2, and is electrically connected to the separating wall 10.

The first connecting means 40 comprises: electroconductive first bolts 41, 41, . . . each comprising at least a shaft 41a (hereinafter may be simply referred to as “first bolts 41”), first through-holes 10h, 10h, . . . which are provided in the separating wall 10 and through which the shafts 41a of the first bolts 41 can be put (hereinafter may be simply referred to as “first through-holes 10h”); first nuts 42, 42, . . . which can engage with the first bolts 41 (hereinafter may be simply referred to as “first nuts 42”); and electroconductive first structural elements 43, 43, . . . (hereinafter may be simply referred to as “first structural elements 43”). The first bolts 41 comprise the shafts 41a, and heads 41b provided at ends on one sides of the shafts 41a. A male screw thread is cut in at least part of each of the shafts 41a.

The first structural elements 43 each comprise: a first spacer portion 43a extending from the anode 20 toward the first face 10a of the separating wall 10 in a direction crossing the first face 10a of the separating wall 10; and a first plate-shaped portion 43b that is continuous from the first spacer portion 43a and extending in a direction parallel to the first face 10a of the separating wall 10. The first spacer portion 43a comprises: an end 43ae fixed to the anode 20. The first plate-shaped portion 43b comprises: a second through-hole 43bh through which the shafts 41a of the first bolts 41 can be put.

The electrolysis element 100 further comprises: a second connecting means 70 fixing the cathode current collector 60 to the separating wall 10 such that the cathode current collector 60 faces the second face 10b of the separating wall 10 at the second distance d2, and electrically connecting the cathode current collector 60 to the separating wall 10. The second connecting means 70 comprises: an electroconductive second structural element 71. The second structural element 71 comprises: a second spacer portion 71a extending between the cathode current collector 60 and the second face 10b of the separating wall 10 in a direction crossing the second face 10b of the separating wall 10. The second structural element 71 also comprises an end 71ec fixed to the cathode current collector; and an end 71ew fixed to the second face 10b of the separating wall 10.

FIG. 2B is an exploded cross-sectional view schematically illustrating the position of the electrolysis element 100 in FIG. 2A, where the union of the first structural elements 43 of the first connecting means 40, and the separating wall 10 is dissolved, and where the union of the cathode current collector 60, the elastic body 50 and the cathode 30 is dissolved. In the electrolysis element 100, the shafts 41a of the first bolts 41 are put through the first through-holes 10h provided in the separating wall 10 and the second through-holes 43bh provided in the first plate-shaped portions 43b, and engage with the first nuts 42, to removably fix the first structural elements 43 to the separating wall 10. That is, the first structural elements 43 and the separating wall 10 are connected by the fastening force of the first bolts 41 and the first nuts 42. This leads the anode 20 to be removably fixed to the separating wall 10 by means of the first bolts 41.

The cathode current collector 60 comprises: third through-holes 60h, 60h, . . . that are provided in a position facing the first through-holes 10h, 10h, . . . of the separating wall 10, and that have shapes and dimensions such that the first nuts 42 can pass therethrough (hereinafter may be simply referred to as “third through-holes 60h”). In the electrolysis element 100, the work of placing the first nuts 42 at positions where the first nuts 42 engage with the first bolts 41, and the work of bolting the first structural elements 43 to the separating wall 10 by the fastening force of the first bolts 41 and the first nuts 42 can be carried out through the third through-holes 60h (see the arrow X). The work of unfastening the first bolts 41 and the first nuts 42, thereby removing the first structural elements 43 from the separating wall 10 can be also carried out through the third through-holes 60h. That is, in the electrolysis element 100, the third through-holes 60h function as openings for access. Providing the third through-holes 60h in the cathode current collector 60 does not prevent a zero-gap electrolysis vessel from being configured with the electrolysis element 100 because the electroconductive elastic body 50 is present between the cathode current collector 60 and the cathode 30.

An alkali-resistant rigid electroconductive material may be used as the material of the separating wall 10. Examples of such a material include simple metals such as nickel and iron; stainless steel such as SUS304, SUS310, SUS310S, SUS316 and SUS316L; and metallic materials obtained by nickeling any of them.

A known anode for generating oxygen which is used for a zero-gap electrolysis vessel for alkaline water electrolysis may be used as the anode 20. The anode 20 generally includes an electroconductive base material, and a catalyst layer covering the surface of the base material. The catalyst layer is preferably porous. For example, nickel, iron, vanadium, molybdenum, copper, silver, manganese, a platinum group metal, graphite, or chromium, or any combination thereof may be used as the electroconductive base material of the anode 20. In the anode 20, an electroconductive base material including nickel may be preferably used. The catalyst layer includes nickel as an element. The catalyst layer preferably includes nickel oxide, metallic nickel, or nickel hydroxide, or any combination thereof, and may include an alloy of nickel and at least another metal. The catalyst layer especially preferably includes metallic nickel. The catalyst layer may further include chromium, molybdenum, cobalt, tantalum, zirconium, aluminum, zinc, a platinum group metal, or a rare earth element, or any combination thereof. Rhodium, palladium, iridium, or ruthenium, or any combination thereof may be further supported on the surface of the catalyst layer as an additional catalyst. The anode 20 may be, for example, a flexible porous plate or a rigid porous plate, and is preferably a rigid porous plate. A porous plate including a rigid electroconductive base material (such as an expanded metal) and any of the above-described catalyst layers may be used as the anode 20 when the anode 20 is a rigid porous plate. A porous plate including a flexible electroconductive base material (such as a wire net woven (or knitted) out of metal wire, and a thin punching metal) and any of the above-described catalyst layers may be used as the anode 20 when the anode 20 is a flexible porous plate.

A known cathode for generating hydrogen which is used for a zero-gap electrolysis vessel for alkaline water electrolysis may be used as the cathode 30. The cathode 30 generally includes an electroconductive base material, and a catalyst layer covering the surface of the base material. For example, nickel, a nickel alloy, stainless steel, mild steel, a nickel alloy, nickeled stainless steel, or nickeled mild steel may be preferably used as the electroconductive base material of the cathode 30. A coating including a noble metal oxide, nickel, cobalt, molybdenum, or manganese, or an oxide or a noble metal oxide thereof may be preferably used as the catalyst layer of the cathode 30. The cathode 30 may be, for example, a flexible porous plate or a rigid porous plate, and is preferably a flexible porous plate. A porous plate including a rigid electroconductive base material (such as an expanded metal) and any of the above-described catalyst layers may be used as the cathode 30 when the cathode 30 is a rigid porous plate. A porous plate including a flexible electroconductive base material (such as a wire net woven (or knitted) out of metal wire, and a thin punching metal) and any of the above-described catalyst layers may be used as the cathode 30 when the cathode 30 is a flexible porous plate.

An electroconductive bolt including: the shaft 41a having a length longer than the total thickness of the separating wall 10, the first plate-shaped portion 43b and the first nut 42; and the head 41b, which is provided at the end of the shaft, may be preferably used as each of the first bolt 41. It is not always necessary to cut a screw thread in the entire shaft 41a as long as a screw thread is cut in a portion of the shaft 41a which is to engage with the first nut 42. The shape of the head 41b is not particularly limited as long as its outer diameter is larger than the second through-hole 43bh provided in the first plate-shaped portion 43b (that is, the head 41b cannot pass through the second through-hole 43bh). For example, a known electroconductive bolt such as a hexagon head bolt may be used as such a first bolt 41. An alkali-resistant rigid electroconductive material may be used as the material of the first bolt 41. Examples of such a material include simple metals such as nickel and iron; stainless steel such as SUS304, SUS310, SUS310S, SUS316 and SUS316L; and metallic materials obtained by nickeling any of them.

An electroconductive nut that can engage with the first bolt 41, and that has an outer diameter larger than the first through-hole 10h provided in the separating wall 10 (that is, cannot pass through the first through-hole 10h) may be used as each of the first nuts 42. For example, a known electroconductive nut such as a hexagon nut may be used as such a first nut 42. An alkali-resistant rigid electroconductive material may be used as the material of the first nut 42. Examples of such a material include simple metals such as nickel and iron; stainless steel such as SUS304, SUS310, SUS310S, SUS316 and SUS316L; and metallic materials obtained by nickeling any of them.

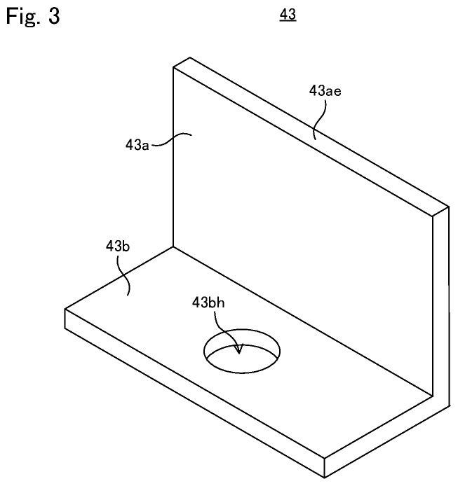

FIG. 3 is a perspective view schematically illustrating one of the first structural elements 43. In FIG. 3, the elements already shown in FIGS. 2A and 2B are given the same reference signs as in FIGS. 2A and 2B, and the description thereof may be omitted. As described above, the first structural element 43 comprises the first spacer portion 43a and the first plate-shaped portion 43b. The first spacer portion 43a extends from the anode 20 toward the first face 10a of the separating wall 10 in a direction crossing the first face 10a of the separating wall 10. The first plate-shaped portion 43b is continuous from the first spacer portion 43a and extends in a direction parallel to the first face 10a of the separating wall 10. The first plate-shaped portion 43b comprises: the second through-hole 43bh, through which the shaft 41a of the first bolt 41 can be put. The first spacer portion 43a comprises: the end 43ae fixed to the anode 20. An alkali-resistant rigid electroconductive material may be used as the material of the first structural element 43. Examples of such a material include simple metals such as nickel and iron; stainless steel such as SUS304, SUS310, SUS310S, SUS316 and SUS316L; and metallic materials obtained by nickeling any of them. In the electrolysis element 100, the end 43ae of the first spacer portion 43a is fixed to the anode 20 by welding, but may be fixed by any other method.

A known electroconductive structural element that is used as an electroconductive rib in an alkaline water electrolysis vessel may be used as each of the second structural elements 71 comprising the second spacer portions 71a. In the electrolysis element 100, the second structural elements 71 protrude from the second face 10b of the separating wall 10. The one ends 71ew are fixed to the second face 10b of the separating wall 10, and the other ends 71ec are fixed to the current collector 60. The shape, the number, and the arrangement of the second structural elements 71 are not particularly limited as long as the current collector 60 can be fixed to and held by the separating wall 10 by means of the second structural elements 71. An alkali-resistant rigid electroconductive material may be used as the material of the second structural elements 71 without particular limitations. Examples of such a material include materials such as simple metals such as nickel and iron; stainless steel such as SUS304, SUS310, SUS310S, SUS316 and SUS316L; and metals obtained by nickeling any of them. In the electrolysis element 100, the second structural elements 71 manufactured separately from the separating wall 10 may be fixed to the separating wall 10 by, for example, welding; or the separating wall 10 and the second structural elements 71 may be formed into one body.

A distance except 0 may be suitably selected as each of the first distance d1 and the second distance d2 without any limitations in particular in view of the thicknesses of anode chambers and cathode chambers in the electrolysis vessel including the electrolysis element 100. It is noted that the first distance d1 is more than the total thickness of the thickness of each of the heads 41b of the first bolts 41 and the thickness of each of the first plate-shaped portions 43b of the first structural elements 43. The first distance d1 and the second distance d2 are each usually no less than 10 mm, and preferably no less than 30 mm.

As the elastic body 50, a known electroconductive elastic body used for an alkaline water electrolysis vessel may be used, and for example, an elastic mat made of an aggregate of metal wires, a coil spring, a leaf spring, or the like which includes an alkali-resistant electroconductive material may be preferably used. Examples of the material of the elastic body 50 include simple metals such as nickel and iron; stainless steel such as SUS304, SUS310, SUS310S, SUS316 and SUS316L; and metals obtained by nickeling any of them. Any known means such as welding, pinning and bolting may be employed for holding the elastic body 50 by the current collector 60 without particular limitations.

As the cathode current collector 60, a known current collector used for an alkaline water electrolysis vessel may be used, and for example, an expanded metal or punching metal made from an alkali-resistant rigid electroconductive material may be preferably used. Examples of the material of the current collector 60 include simple metals such as nickel and iron; stainless steel such as SUS304, SUS310, SUS310S, SUS316 and SUS316L; and metals obtained by nickeling any of them. Any known means such as welding and pinning may be employed for holding the current collector 60 at the ends 71ec of the second spacer portions 71a without particular limitations.

FIGS. 2A and 2B will be referred to again. The work of attaching the anode 20 to the separating wall 10 may be carried out by, for example, the steps of: (a) putting the shafts 41a of the first bolts 41 through the second through-holes 43bh provided in the first structural elements 43, which is joined to the anode 20; (b) further putting the shafts 41a of the first bolts 41 through the through-holes 10h of the separating wall 10; and (c) engaging the shafts 41a of the first bolts 41 with the first nuts 42 inserted through the through-holes 60h of the current collector 60, in the order mentioned. It is impossible to put the shafts 41a of the first bolts 41 through the second through-holes 43bh of the first plate-shaped portions 43b in a state where the anode 20 and the first structural elements 43 are joined to each other when the first bolts 41 are longer than the distance between the anode 20 and any of the respective first plate-shaped portions 43b. Even in such a case, the above-described step (a) can be carried out by the steps of: (a1) putting the shafts 41a of the first bolts 41 through the second through-holes 43bh of the first plate-shaped portions 43b in a state where the first structural elements 43 are not fixed to the anode 20; and (a2) fixing the ends 43ae of the first structural elements 43 to the anode 20, in the order mentioned. The work of removing the anode 20 from the electrolysis element 100 may be carried out by, for example, the steps of: (d) removing the cathode 30 and the elastic body 50 from the cathode current collector 60; (e) inserting a jig or the like through the through-holes 60h of the current collector 60 to remove the first nuts 42 from the shafts 41a of the first bolts 41; and (f) pulling to remove the anode 20, and the first structural elements 43 joined to the anode 20 from the separating wall 10, in the order mentioned. For the purpose of preventing the first bolts 41 from co-rotating with the first nuts 42, the step (a) may further include the step of fixing the heads 41b of the first bolts 41 to the first plate-shaped portions 43b of the first structural elements 43 by a known means such as welding and brazing. Like this, the electrolysis element 100 allows easy work of replacing the anode 20, and thus, can reduce time and cost required for renewal of the anode 20.

The electrolysis element 100 comprising the first connecting means 40 including two sets of the first structural elements 43, the first bolts 41, and the first nuts 42 has been described above concerning the present invention as an example. The present invention is not limited to this embodiment. The set(s) of the first structural element(s) 43, the first bolt(s) 41, and the first nut(s) 42 in any number may be included in the first connecting means 40.

The electrolysis element 100 comprising the first structural elements 43 each including the first plate-shaped portion 43b provided with the only one second through-hole 43bh has been described above concerning the present invention as an example. The present invention is not limited to this embodiment. For example, the electrolysis element may comprise first structural elements each including a first plate-shaped portion provided with plural second through-holes.

The electrolysis element 100 comprising the first structural elements 43 each including the single first spacer portion 43a and the single first plate-shaped portion 43b has been described above concerning the present invention as an example. The present invention is not limited to this embodiment. For example, the electrolysis element may comprise first structural elements each including a single first spacer portion, and plural first plate-shaped portions separated from each other and provided continuously from the single first spacer portion. For example, the electrolysis element may comprise first structural elements each including plural first spacer portions separated from each other, and a single first plate-shaped portion provided continuously from the plural first spacer portions.

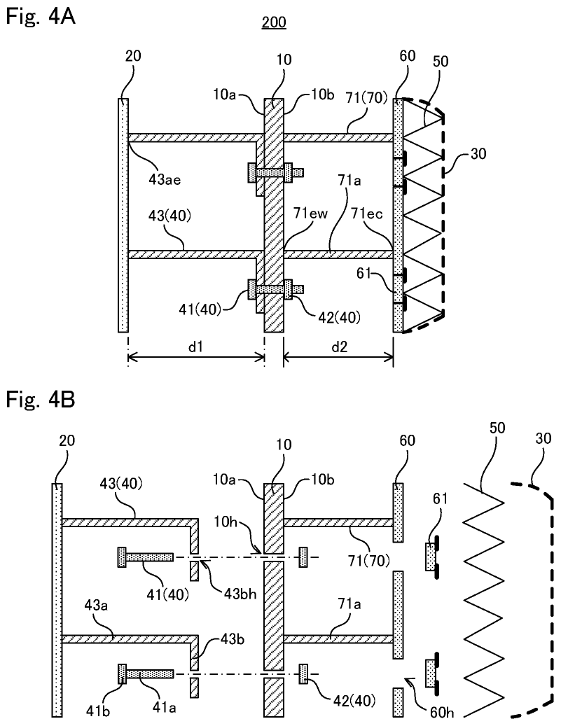

The electrolysis element 100 comprising the cathode current collector 60 supporting the elastic body 50 with the third through-holes 60h, which are provided in the cathode current collector 60, not covered has been described above concerning the present invention as an example. The present invention is not limited to this embodiment. For example, the electrolysis element may comprise removable lid members covering at least part of the respective third through-holes 60h provided in the cathode current collector 60. FIG. 4A is a cross-sectional view schematically illustrating an electrolysis element 200 for alkaline water electrolysis according to such another embodiment (hereinafter may be referred to as “electrolysis element 200”), and corresponds to FIG. 2A. In FIGS. 4A and 4B, the elements already shown in FIGS. 2A to 3 are given the same reference signs as in FIGS. 2A to 3, and the description thereof may be omitted. The electrolysis element 200 is different from the electrolysis element 100 (FIGS. 2A and 2B) in further comprising electroconductive and removable first lid members 61, 61, . . . covering at least part of the respective third through-holes 60h, 60h, . . . of the cathode current collector 60 (hereinafter may be simply referred to as “first lid members 61”).

FIG. 4B is an exploded cross-sectional view schematically illustrating the position of the electrolysis element 200 in FIG. 4A, where the union of the first structural elements 43 of the first connecting means 40, and the separating wall 10 is dissolved, where the union of the cathode current collector 60, the elastic body 50 and the cathode 30 is dissolved, and where the first lid members 61 are removed from the third through-holes 60h, and corresponds to FIG. 2B. The first lid members 61 have shapes corresponding to the third through-holes 60h of the cathode current collector 60, and can be put on the cathode current collector 60 to cover at least part of the respective third through-holes 60h. When put on the cathode current collector 60 to cover at least part of the respective third through-holes 60h, the first lid members 61 are electrically connected to the cathode current collector 60.

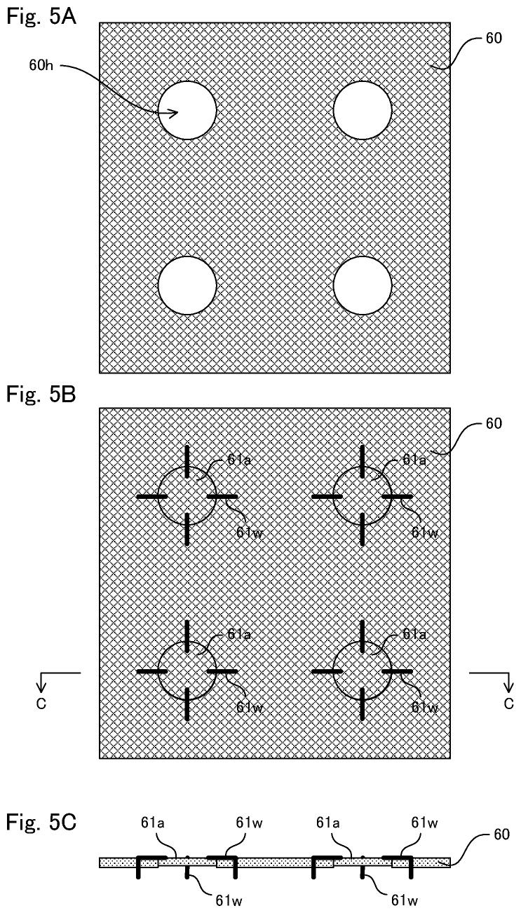

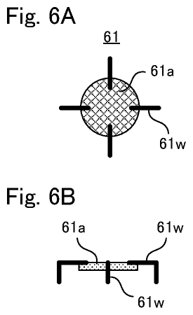

FIGS. 5A to 6B schematically illustrate the cathode current collector 60 and the first lid members 61. FIG. 5A is a plan view of the cathode current collector 60. As shown in FIG. 5A, the cathode current collector 60 comprises the third through-holes 60h, 60h, . . . . The cathode current collector 60 is a porous plate made from an expanded metal. FIG. 5B is a plan view showing the position of the first lid members 61, 61, . . . put in the third through-holes 60h, 60h, . . . of the cathode current collector 60 in FIG. 5A. FIG. 5C shows FIG. 5B viewed in the direction indicated by the arrow C-C. FIG. 6A is a plan view schematically illustrating one of the first lid members 61. FIG. 6B is a front view of FIG. 6A which also serves as right and left side views thereof. As shown in FIGS. 6A and 6B, the first lid member 61 has an electroconductive flat surface part 61a having a shape corresponding to the third through-hole 60h, and L-shaped wire parts 61w, 61w, . . . joined to the flat surface part 61a (hereinafter may be simply referred to as “wire parts 61w”). The flat surface part 61a may be made from, for example, an expanded metal as the cathode current collector 60 is, or for example, a metal plate. As shown in FIGS. 5B and 5C, the flat surface parts 61a of the first lid members 61 are inserted into the third through-holes 60h of the cathode current collector 60, and the wire parts 61w joined to the flat surface parts 61a are put in pores of the expanded metal that forms the cathode current collector 60; thereby the first lid members 61 are removably put in the cathode current collector 60, and the cathode current collector 60 and the flat surface parts 61a of the first lid members 61 are electrically connected to each other.

For example, an expanded metal, a punching metal or a metal plate which is made from an alkali-resistant rigid electroconductive material may be preferably used as the flat surface parts 61a of the first lid members 61. Examples of the material of the flat surface parts 61a include simple metals such as nickel and iron; stainless steel such as SUS304, SUS310, SUS310S, SUS316 and SUS316L; and metals obtained by nickeling any of them.

A metal wire made from an alkali-resistant rigid electroconductive material may be used as the wire parts 61w of the first lid members 61. Examples of the material of the wire parts 61w include simple metals such as nickel and iron; stainless steel such as SUS304, SUS310, SUSs310S, SUS316 and SUS316L; and metals obtained by nickeling any of them. For joining the wire parts 61w to the flat surface parts 61a, any known means such as welding and brazing may be employed without particular limitations.

Such an electrolysis element 200 can ensure more uniformity of the force by which the elastic body 50 is supported from the back because at least part of a portion of the elastic body 50 which corresponds to the third through-holes 60h in a portion thereof which contacts with the cathode current collector 60 is covered with the first lid members 61. This can ensure more uniformity of the force by which the elastic body 50 pushes the cathode 30 toward the separating membrane and the anode in a zero-gap electrolysis vessel comprising the electrolysis element 200. Such an electrolysis element 200 also allows easy work of replacing the anode 20, and thus, can reduce time and cost required for renewal of the anode 20, as described above concerning the electrolysis element 100.

The electrolysis element 200 comprising the first lid members 61 including the flat surface parts 61a, which have shapes corresponding to the third through-holes 60h of the cathode current collector 60, and which are fitted into the third through-holes 60h when the first lid members 61 cover at least part of the respective third through-holes 60h of the cathode current collector has been described above concerning the present invention as an example. The present invention is not limited to this embodiment. For example, the electrolysis element may comprise first lid members having flat surface parts that are larger than the third through-holes 60h, and that are supported by the peripheries of the third through-holes 60h when the first lid members are put to cover the entire third through-holes 60h of the cathode current collector. For example, the electrolysis element may comprise first lid members covering only part of the respective third through-holes 60h of the cathode current collector 60. For example, when any of the first lid members are put in the cathode current collector 60, a gap may be present between the periphery of the flat surface part of the first lid member and the inner periphery of the third through-hole 60h of the cathode current collector 60.

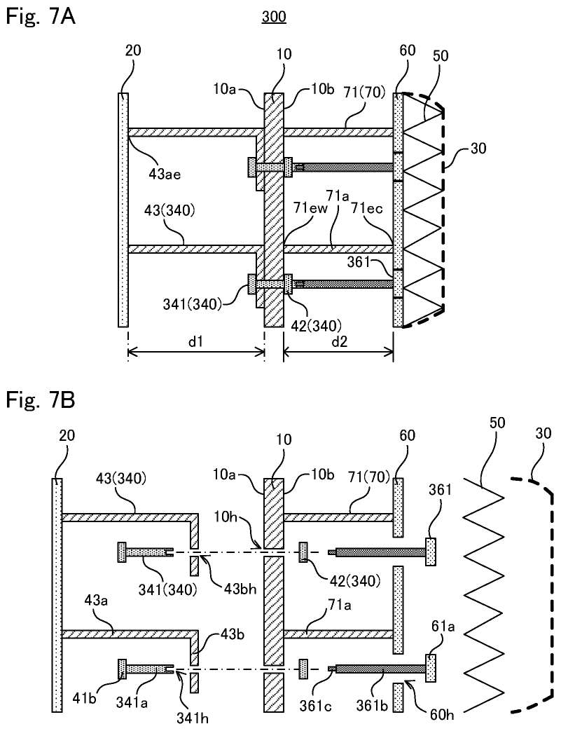

The electrolysis element 200 comprising the first lid members 61, which include the electroconductive flat surface parts 61a, and the L-shaped wire parts 61w joined to the flat surface parts 61a, wherein the flat surface parts 61a of the first lid members 61 are inserted into the third through-holes 60h of the cathode current collector 60, and the wire parts 61w joined to the flat surface parts 61a are put in pore of the expanded metal that forms the cathode current collector 60; thereby the first lid members 61 are put in the cathode current collector 60, and the cathode current collector 60 and the flat surface parts 61a of the first lid members 61 are electrically connected to each other has been described above concerning the present invention as an example. The present invention is not limited to this embodiment. For example, the electrolysis element may comprise first lid members including screws protruding from the flat surface parts, and the first bolts 41 provided with, at their ends on one side, threaded holes with which the screws of the first lid members are engaged, and thereby, the first lid members are fixed. FIGS. 7A and 7B are cross-sectional views schematically illustrating an electrolysis element 300 for alkaline water electrolysis according to such another embodiment (hereinafter may be referred to as “electrolysis element 300”), and corresponds to FIGS. 2A and 4A. In FIGS. 7A and 7B, the elements already shown in FIGS. 2A to 6B are given the same reference signs as in FIGS. 2A to 6B, and the description thereof may be omitted. The electrolysis element 300 is different from the electrolysis element 200 (FIGS. 4A to 6B) in comprising first lid members 361 instead of the first lid members 61, and a first connecting means 340 instead of the first connecting means 40.

FIG. 7B is an exploded cross-sectional view schematically illustrating the position of the electrolysis element 300 in FIG. 7A, where the union of the first structural elements 43 of the first connecting means 340, and the separating wall 10 is dissolved, where the union of the cathode current collector 60, the elastic body 50 and the cathode 30 is dissolved, and where the first lid members 61 are removed from the third through-holes 60h, and corresponds to FIGS. 2B and 4B.

The first lid members 361 are different from the first lid members 61 (FIG. 4A to 6B) in comprising extension shafts 361b protruding from the flat surface parts 61a, instead of the wire parts 61w, and lid member fixing screws 361c provided at ends of the extension shafts 361b (ends on the side opposite to the flat surface parts 61a).

The first connecting means 340 is different from the first connecting means 40 in comprising first bolts 341 instead of the first bolts 41. The first bolts 341 are different from the first bolts 41 in comprising shafts 341a instead of the shafts 41a. The shafts 341a are different from the shafts 41a in comprising bolt end threaded holes 341h at their ends on the side opposite to the heads 41b. The bolt end threaded holes 341h are threaded holes that can engage with the lid member fixing screws 361c.

The first lid members 361 have shapes that enable the first lid members 361 to cover at least part of the respective third through-holes 60h of the cathode current collector 60 (for example, shapes corresponding to the third through-holes 60h), and can be put in the cathode current collector 60 to cover the third through-holes 60h. In the electrolysis element 300, the lid member fixing screws 361c are engaged with the bolt end threaded holes 341h, and thereby, the first lid members 361 are removably fixed to the first bolts 341, and put in the cathode current collector 60 to cover at least part of the respective third through-holes 60h. When put in the cathode current collector 60 to cover at least part of the respective third through-holes 60h, the first lid members 361 are electrically connected to the cathode current collector 60 via the first bolts 341, the separating wall 10, and the second structural elements 71.

As the material of the extension shafts 361b and the lid member fixing screws 361c, an alkali-resistant rigid electroconductive material may be used, and examples thereof include simple metals such as nickel and iron; stainless steel such as SUS304, SUS310, SUS310S, SUS316 and SUS316L; and metals obtained by nickeling any of them. Each of the extension shafts 361b and each of the lid member fixing screws 361c may be formed into one body, or joined by, for example, welding. For joining the extension shafts 361b to the flat surface parts 61a, any known means such as welding and brazing may be employed without particular limitations.

Such an electrolysis element 300 can ensure more uniformity of the force by which the elastic body 50 is supported from the back because at least part of a portion of the elastic body 50 which corresponds to the third through-holes 60h in a portion thereof which contacts with the cathode current collector 60 is covered with the first lid members 361. This can ensure more uniformity of the force by which the elastic body 50 pushes the cathode 30 toward the separating membrane and the anode in a zero-gap electrolysis vessel comprising the electrolysis element 300. Such an electrolysis element 300 also allows easy work of replacing the anode 20, and thus, can reduce time and cost required for renewal of the anode 20, as described above concerning the electrolysis element 100.

The electrolysis element 300 comprising the first lid members 361 each having the extension shaft 361b fixed to the flat surface part 61a, and the lid member fixing screw 361c provided at the end of the extension shaft 361b has been described above concerning the present invention as an example. The present invention is not limited to this embodiment. For example, the electrolysis element may comprise a first lid member including the lid member fixing screw 361c directly fixed to the flat surface part 61a. For example, the electrolysis element may comprise a first lid member including a flat surface part fixed to a head provided at an end of a lid member fixing screw.

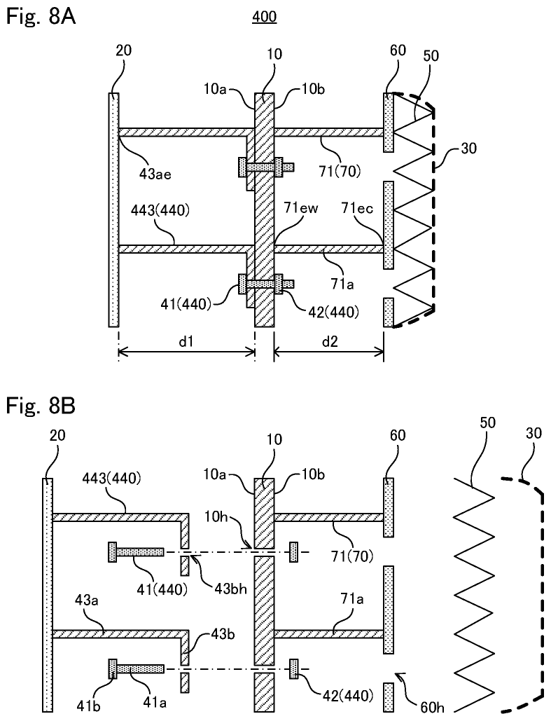

The electrolysis elements 100, 200 and 300 each comprising the first structural elements 43 each comprising the spacer portion 43a and the first plate-shaped portion 43b have been described above concerning the present invention as an example. The present invention is not limited to this embodiment. For example, the electrolysis element may comprise the first structural elements each further comprising: a rotation-limiting portion, wherein when the shaft 41a of the first bolt 41 is put through the second through-hole 43bh and the head 41b of the first bolt 41 contacts with the first plate-shaped portion 43b, the rotation-limiting portion contacts with the side surface of the head 41b of the first bolt 41, to limit rotation of the first bolt 41. FIG. 8A is a cross-sectional view schematically illustrating an electrolysis element 400 for alkaline water electrolysis according to such another embodiment (hereinafter may be referred to as “electrolysis element 400”), and corresponds to FIG. 2A. In FIGS. 8A and 8B, the elements already shown in FIGS. 2A to 7B are given the same reference signs as in FIGS. 2A to 7B, and the description thereof may be omitted. The electrolysis element 400 is different from the electrolysis element 100 in comprising a first connecting means 440 instead of the first connecting means 40. The first connecting means 440 is different from the first connecting means 40 in comprising a first structural element 443 instead of the first structural element 43. FIG. 8B is an exploded cross-sectional view schematically illustrating the position of the electrolysis element 400 in FIG. 8A, where the union of the first structural elements 443 of the first connecting means 440, and the separating wall 10 is dissolved, and where the union of the cathode current collector 60, the elastic body 50 and the cathode 30 is dissolved, and corresponds to FIG. 2B.

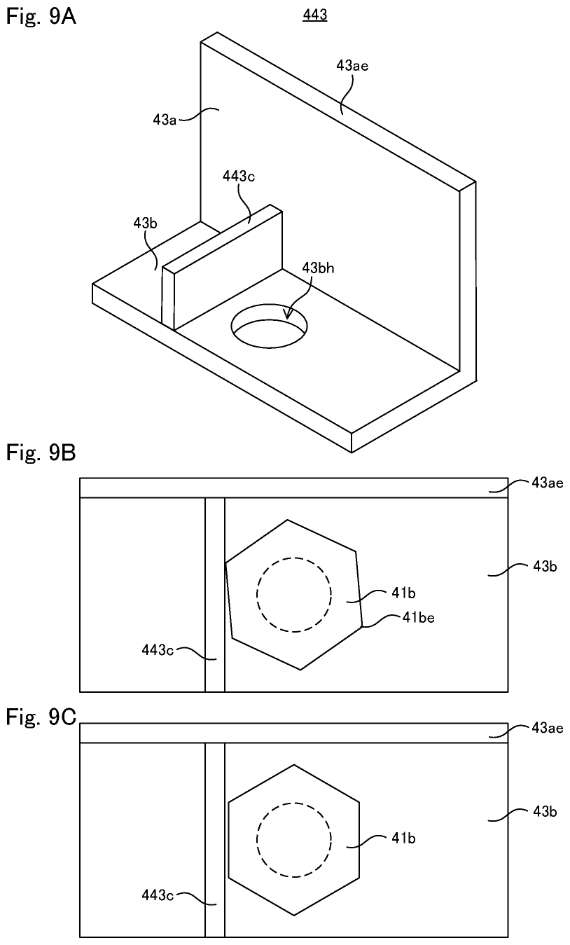

FIG. 9A is a perspective view schematically illustrating one of the first structural elements 443, and corresponds to FIG. 3. In FIGS. 9A to 9C, the elements already shown in FIGS. 2A to 8B are given the same reference signs as in FIGS. 2A to 8B, and the description thereof may be omitted. The first structural element 443 is different from the first structural element 43 (FIG. 3) in further comprising a rotation-limiting portion 443c in addition to the first spacer portion 43a and the first plate-shaped portion 43b. The rotation-limiting portion 443c is a plate-shaped member protruding from the first plate-shaped portion 43b. An alkali-resistant rigid electroconductive material may be used as the material of the rotation-limiting portion 443c. Examples of such a material include simple metals such as nickel and iron; stainless steel such as SUS304, SUS310, SUS310S, SUS316 and SUS316L; and metallic materials obtained by nickeling any of them. The same material as the first plate-shaped portion 43b may be preferably used. The rotation-limiting portion 443c and the first plate-shaped portion 43b may be formed into one body. The rotation-limiting portion 443c may be joined to the first plate-shaped portion by welding or the like.

FIG. 9B is a plan view of one example of the position of the shaft 41a of the first bolt 41 put through the second through-hole 43bh of the first structural element 443 of FIG. 9A which is viewed from the upper side of the sheet of FIG. 9A. FIG. 9B shows the end 43ae of the spacer portion 43a, the first plate-shaped portion 43b, the rotation-limiting portion 443c, and the head 41b of the first bolt 41. In the electrolysis element 400, the first bolts 41 are hexagon head bolts. As shown in FIG. 9B, when the shaft 41a of the first bolt 41 is put through the second through-hole 43bh of the first structural element 443 and the head 41b of the first bolt 41 contacts with the first plate-shaped portion 43b, the rotation-limiting portion 443c contacts with the side surface (periphery) of the head 41b, and thereby, the rotation of the first bolt 41 is limited. As shown in FIG. 9B, the rotation-limiting portion 443c “contacts with the side surface of the head 41b, and thereby, the rotation of the first bolt 41 is limited” means that it is limited for the first bolt 41 to freely rotate, but it is not required to completely limit the rotation of the first bolt 41. In the first structural element 443, when the first bolt 41 rotates, some corner part 41be present on the side surface of the head 41b of the first bolt 41 contacts with the rotation-limiting portion 443c; thereby it is limited for the first bolt 41 to freely rotate. In the state where the rotation-limiting portion 443c “contacts with the side surface of the head 41b, and thereby, the rotation of the first bolt 41 is limited”, it is not required for the rotation-limiting portion 443c to be always in contact with the side surface of the head 41b of the first bolt 41. FIG. 9C is a plan view of another example of the position of the shaft 41a of the first bolt 41 put through the second through-hole 43bh of the first structural element 443 of FIG. 9A which is viewed from the upper side of the sheet of FIG. 9A. As shown in FIG. 9C, when one of the flat faces forming the side surface of the head 41b of the first bolt 41 is at a position parallel to the rotation-limiting portion 443c, there may be a gap between the rotation-limiting portion 443c and the head 41b of the first bolt 41.

The first structural element 443c comprising such a rotation-limiting portion 443c can prevent the first bolt 41 from co-rotating with the first nut 42 when the shaft of the first bolt 41 engages with the first nut 42. Thus, the electrolysis element 400 makes the works of putting and removing the anode 20 easier. Such an electrolysis element 400 also allows easy work of replacing the anode 20, and thus, can reduce time and cost required for renewal of the anode 20, as described above concerning the electrolysis element 100.

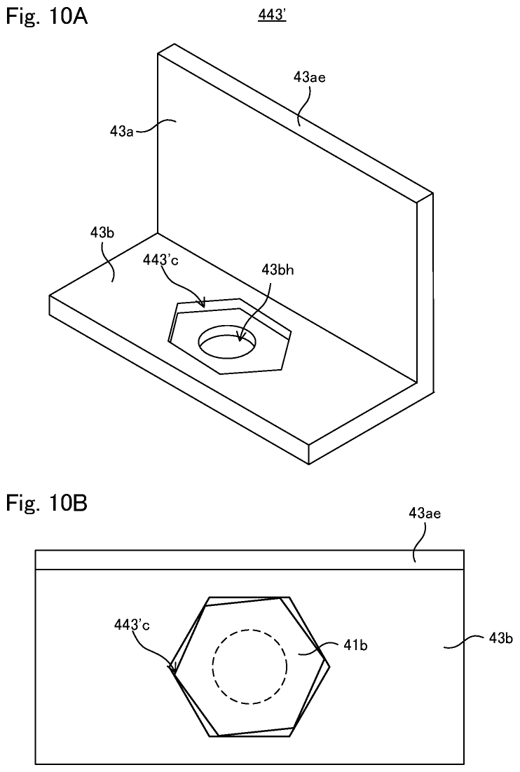

The electrolysis element 400 comprising the first structural elements 443 each having a plate-shaped member protruding from the first plate-shaped portion 43b as the rotation-limiting portion 443c has been described above concerning the present invention as an example. The present invention is not limited to this embodiment. The structure of the rotation-limiting portion is not particularly limited as long as the rotation of the first bolt can be limited by the contact of the rotation-limiting portion with the head of the first bolt. For example, the electrolysis element may comprise a first structural element shaped to have a structure of limiting the rotation of the first bolt by the contact of the structure with the head of the first bolt, by casting, pressing, cutting, or the like. One example of such a structure is a structure of a first structural element shaped to have a depressed portion having a shape corresponding to the head 41b of the first bolt 41, around the second through-hole 43bh of the first plate-shaped portion 43b. FIG. 10A is a perspective view schematically illustrating a first structural element 443′ according to such another embodiment, and corresponds to FIG. 9A. In FIGS. 10A and 10B, the elements already shown in FIGS. 2A to 9C are given the same reference signs as in FIGS. 2A to 9C, and the description thereof may be omitted. As shown in FIG. 10A, in the first structural element 443′, a depressed portion 443′c having a shape corresponding to the head 41b of the first bolt 41, which is a hexagon head bolt, is provided around the second through-hole 43bh in the plate-shaped portion 43b. This depressed portion 443′c functions as a rotation-limiting portion. FIG. 10B is a plan view of the position of the shaft 41a of the first bolt 41 put through the second through-hole 43bh of the first structural element 443′ of FIG. 10A which is viewed from the upper side of the sheet of FIG. 10A. FIG. 10B shows the end 43ae of the spacer portion 43a, the first plate-shaped portion 43b, the rotation-limiting portion 443′c, and the head 41b of the first bolt 41. As shown in FIG. 10B, when the shaft 41a of the first bolt 41 is put through the second through-hole 43bh of the first structural element 443′ and the head 41b of the first bolt 41 contacts with the first plate-shaped portion 43b, the side surface of the depressed portion 443′c, which is a rotation-limiting portion, contacts with the side surface (periphery) of the head 41b (that is, the periphery of the head 41b of the first bolt 41 contacts with the side surface of the depressed portion 443′c (which is a rotation-limiting portion)), and thereby, the rotation of the first bolt 41 is limited. The same effect as obtained from the above-described rotation-limiting portion 443c can be also obtained from such a rotation-limiting portion 443′c that is a depressed portion. In the above description, the first structural element 443′ having the hexagonal depressed portion 443′c corresponding to the shape of the head 41b of the first bolt 41, which is a hexagon head bolt, as a rotation-limiting portion is illustrated. The present invention is not limited to this embodiment. The first structural element may have, for example, a polygonal (such as hexagonal) depressed portion having round vertexes, as a rotation-limiting portion.

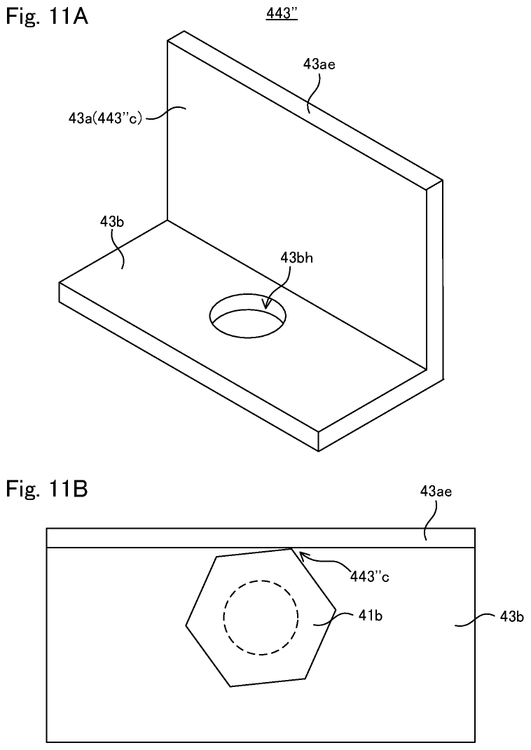

For example, in the electrolysis element, one may arrange the second through-holes 43bh at positions close to the first spacer portions 43a; thereby the rotation of the heads 41b is limited by the contact of the side surfaces of the heads 41b of the first bolts 41, which are put through the second through-holes 43bh, with the first spacer portions 43a, that is, the first spacer portions 43a may function as a rotation-limiting portion. FIG. 11A is a perspective view schematically illustrating a first structural element 443″ according to such another embodiment, and corresponds to FIG. 9A. In FIGS. 11A and 11B, the elements already shown in FIGS. 2A to 10B are given the same reference signs as in FIGS. 2A to 10B, and the description thereof may be omitted. As shown in FIG. 11A, in the first structural element 443″, the second through-hole 43bh in the plate-shaped portion 43b is provided in close vicinity to the spacer portion 43a, and the spacer portion 43a also functions as a rotation-limiting portion 443″c. FIG. 11B is a plan view of the position of the shaft 41a of the first bolt 41 put through the second through-hole 43bh of the first structural element 443″ of FIG. 11A which is viewed from the upper side of the sheet of FIG. 11A. FIG. 11B shows the end 43ae of the spacer portion 43a, the first plate-shaped portion 43b, and the head 41b of the first bolt 41. As shown in FIG. 11B, when the shaft 41a of the first bolt 41 is put through the second through-hole 43bh of the structural element 443″ and the head 41b of the first bolt 41 contacts with the first plate-shaped portion 43b, the spacer portion 43a, which also functions as a rotation-limiting portion, contacts with the side surface (periphery) of the head 41b, and thereby, the rotation of the first bolt 41 is limited. The same effect as obtained from the above-described rotation-limiting portion 443c can be also obtained from such a spacer portion that also functions as a rotation-limiting portion.

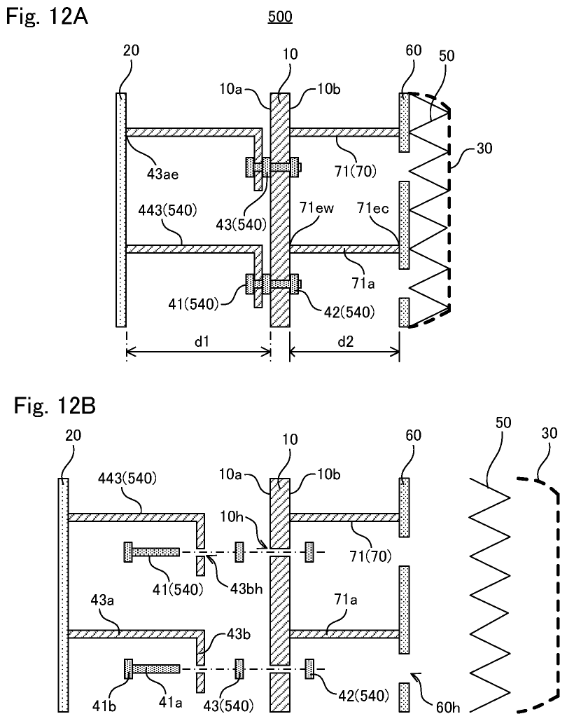

The electrolysis element 100, 200, 300 or 400 wherein the first bolts 41 or 341, the first structural elements 43 or 443, and the separating wall 10 are fixed to one another by the fastening force of the first bolts 41 or 341, and the first nuts 42 has been described above concerning the present invention as an example. The present invention is not limited to this embodiment. For example, the electrolysis element may further comprise second nuts with which the first bolts and the first structural elements are fixed. FIG. 12A is a cross-sectional view schematically illustrating an electrolysis element 500 for alkaline water electrolysis according to such another embodiment (hereinafter may be referred to as “electrolysis element 500”), and corresponds to FIG. 8A. In FIGS. 12A and 12B, the elements already shown in FIGS. 2A to 11B are given the same reference signs as in FIGS. 2A to 11B, and the description thereof may be omitted. The electrolysis element 500 is different from the electrolysis element 400 (FIGS. 8A to 11B) in comprising a first connecting means 540 instead of the first connecting means 440.

FIG. 12B is an exploded cross-sectional view schematically illustrating the position of the electrolysis element 500 in FIG. 12A, where the union of the first structural elements 443 of the first connecting means 540, and the separating wall 10 is dissolved, where the union of the cathode current collector 60, the elastic body 50 and the cathode 30 is dissolved, and where the union of the first structural elements 443 and the first bolts 41 is dissolved, and corresponds to FIG. 8B.

The first connecting means 540 is different from the first connecting means 440 in further comprising second nuts 44, 44, . . . that can engage with the first bolts 41, 41, . . . (hereinafter may be simply referred to as “second nuts 44”). In FIG. 12B, after the shafts 41a of the first bolts 41 are put through the second through-holes 43bh of the first plate-shaped portions 43b, the second nuts 44 engage with the shafts 41a of the first bolts 41, such that the heads 41b of the first bolts 41 and the second nuts 44 sandwich the first plate-shaped portions 43b, to fix the first bolts 41 to the first plate-shaped portions 43b. Thereafter the shafts 41 of the first bolts 41 fixed to the first plate-shaped portions 43b are put through the first through-holes 10h of the separating wall 10 and engage with the first nuts 42, to fix the first bolts 41 to the separating wall 10 (FIG. 12A).

Electroconductive nuts that can engage with the first bolts 41, and that each have a larger outer diameter than each of the first through-holes 10h provided in the separating wall 10, and each of the second through-holes 43bh provided in the first plate-shaped portions 43b (that is, that cannot pass through the first through-holes 10h or the second through-holes 43bh) may be used as the second nuts 44. For example, known electroconductive nuts such as a hexagon nut may be used as such second nuts 44. An alkali-resistant rigid electroconductive material may be used as the material of the second nuts 44. Examples of such a material include simple metals such as nickel and iron; stainless steel such as SUS304, SUS310, SUS310S, SUS316 and SUS316L; and metallic materials obtained by nickeling any of them.

Such an electrolysis element 500 allows the work of putting the shafts 41a of the first bolts 41, which are put through the second through-holes 43bh of the first plate-shaped portions 43b, through the first through-holes 10h of the separating wall 10 for attaching the anode 20 to the separating wall 10 to be carried out in a state where the first bolts 41 are fixed to the first plate-shaped portions already. This prevents the first bolts 41 from fluctuating during this work, and from coming off from the second through-holes 43bh, which allows easier work of attaching the anode 20 to the separating wall 10. Such an electrolysis element 500 also allows easy work of replacing the anode 20, and thus, can reduce time and cost required for renewal of the anode 20, as described above concerning the electrolysis element 100.

The electrolysis element 500 comprising the first structural elements 443 each having the rotation-limiting portion 443c has been described above concerning the present invention as an example. The present invention is not limited to this embodiment. For example, the electrolysis element 500 (FIGS. 12A and 12B) may comprise the first structural elements 43 (FIG. 3) having no rotation-limiting portion, instead of the first structural elements 443 (FIGS. 9A to 9C). According to the electrolysis element 500 comprising the first structural elements 443 each having the rotation-limiting portion 443c, the rotation-limiting portion 443c prevents the first bolt 41 from co-rotating with the first nut 41 when the shaft 41b of the first bolt 41 engages with the first nut 41, which is preferable. In contrast, even when the first structural elements have no rotation-limiting portion, the first bolts 41 and the second nuts 44 fasten the first plate-shaped portions 43b, and thereby, the rotation of the first bolt 41 is suppressed in some degree. Thus, it is suppressed in some degree that the first bolts 41 co-rotate with the first nuts 42 when the shafts 41b of the first bolts 41 engage with the first nuts 42, and therefore, sufficient fastening can be performed.

The electrolysis elements 400 and 500 comprising no first lid member covering at least part of the third through-hole 60h of the cathode current collector 60 have been described above concerning the present invention as an example. The present invention is not limited to this embodiment. For example, as described above with reference to the electrolysis element 200 (FIGS. 4A to 6B) and the electrolysis element 300 (FIGS. 7A and 7B), the electrolysis element may further comprise first lid members covering at least part of the respective third through-holes 60h of the cathode current collector 60.

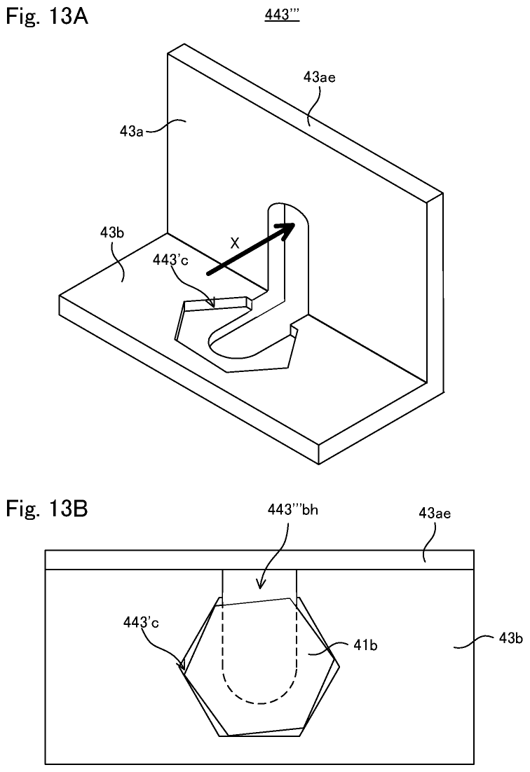

The electrolysis element 100, 200, 300, 400 or 500 comprising the first structural elements 43, 443, 443′ or 443″ including the first plate-shaped portions 43b provided with the second through-holes 43bh each having a round cross section has been described above concerning the present invention as an example. The present invention is not limited to this embodiment. For example, the electrolysis element may comprise a first structural element including a second through-hole provided continuously from the first plate-shaped portion to at least part of the first spacer portion. FIG. 13A is a perspective view schematically illustrating a first structural element 443′″ according to such another embodiment, and corresponds to FIG. 10A. In FIGS. 13A and 13B, the elements already shown in FIGS. 2A to 12B are given the same reference signs as in FIGS. 2A to 12B, and the description thereof may be omitted. As shown in FIG. 13A, the first structural element 443′″ is different from the first structural element 443′ (FIGS. 10A and 10B) in comprising a second through-hole 443′″bh instead of the second through-hole 43bh. The second through-hole 443′″bh is different from the second through-hole 43b provided only in the first plate-shaped portion 43b in being provided continuously from the first plate-shaped portion 43b to at least part of the first spacer portion 43a. FIG. 13B is a plan view of one example of the position of the shaft 41a of the first bolt 41 put through the second through-hole 443′″bh of the first structural element 443′″ of FIG. 13A which is viewed from the upper side of the sheet of FIG. 13A. FIG. 13B shows the end 43ae of the spacer portion 43a, the first plate-shaped portion 43b, the rotation-limiting portion 443c, the second through-hole 443′″bh, and the head 41b of the first bolt 41. Such a first structural element 443′″ allows the first bolt 41 to be arranged in such a manner that when the shaft 41a of the first bolt 41 is put through the second through-hole 443′″bh, the shaft 41a of the first bolt 41 is put through a portion of the second through-hole 443′″bh, which is provided in the spacer portion 43a (arrow X in FIG. 13A), and thereafter, the direction of the first bolt is changed, and thereby the head 41b of the first bolt 41 contacts with the first plate-shaped portion 43b as shown in the FIG. 13B. When the height of the spacer portion 43a (distance from the first plate-shaped portion 43b to the anode 20) is shorter than the length of the first bolt 41 in the first structural element 43 (FIG. 3), 443 (FIGS. 9A to 9C), 443′ (FIGS. 10A and 10B) or 443″ (FIGS. 11A and 11B) including the second through-hole 43bh provided only in the first plate-shaped portion 43b, it is necessary to put the first bolt 41 through the second through-hole 43b, and thereafter, join the first structural element to the anode 20 by welding or the like. In contrast, the electrolysis element comprising the first structural element 443′″ (FIGS. 13A and 13B) having the second through-hole 443′″bh provided continuously from the first plate-shaped portion 43b to at least part of the first spacer portion 43a allows the shaft 41a of the first bolt 41 to be put through the second through-hole 443′″bh in a state where the first structural element 443′″ is joined to the anode 20 already even when the height of the spacer portion 43a (distance from the first plate-shaped portions 43b to the anode 20) is less shorter than the length of the first bolt 41. This allows easier work of attaching the anode 20 to the separating wall 10 even when the distance d1 from the separating wall 10 to the anode 20 is short. FIGS. 13A and 13B illustrate the first structural element 443′″ provided with the rotation-limiting portion 443′c, which is a depressed portion having a shape corresponding to the head 41b of the first bolt 41, which is a hexagon head bolt, around the second through-hole 443′″bh. The first structural element may comprise a rotation-limiting portion according to another embodiment, or no rotation-limiting portion. For example, the rotation-limiting portion 443c (FIGS. 9A to 9C), which is a plate-shaped member, may be provided. In view of easier positioning of the first bolt 41, the first structural element 443′″ provided with the rotation-limiting portion 443′c, which is a depressed portion having a shape corresponding to the head 41b of the first bolt 41 (for example, a polygon or a polygon having round vertexes), around the second through-hole 443′″bh may be preferably used.

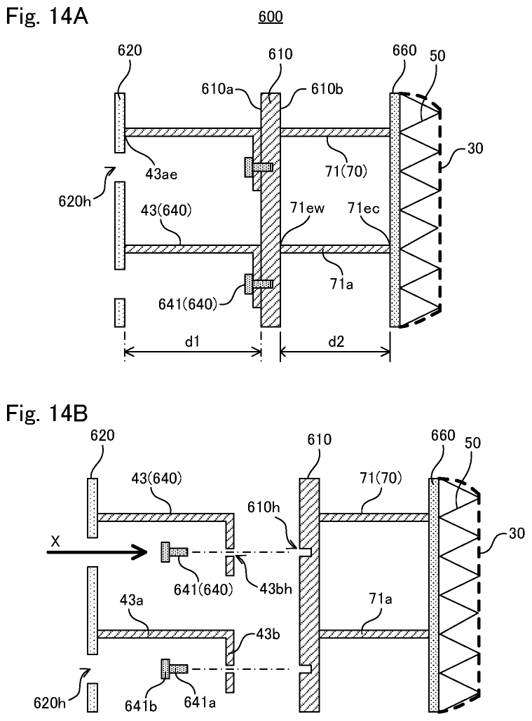

The electrolysis elements 100, 200, 300, 400 and 500 each comprising the separating wall 10 including the through-holes 10h have been described above concerning the present invention as an example. The present invention is not limited to this embodiment. For example, the electrolysis element may comprise a separating wall including threaded holes opening in the first face, instead of the through-holes. FIG. 14A is a cross-sectional view schematically illustrating an electrolysis element 600 for alkaline water electrolysis according to such another embodiment (hereinafter may be referred to as “electrolysis element 600”), and corresponds to FIG. 2A. In FIGS. 14A and 14B, the elements already shown in FIGS. 2A to 13B are given the same reference signs as in FIGS. 2A to 13B, and the description thereof may be omitted. The electrolysis element 600 is different from the electrolysis element 100 (FIGS. 2A and 2B) in comprising a separating wall 610 instead of the separating wall 10, an anode 620 instead of the anode 20, a cathode current collector 660 instead of the cathode current collector 60, and a first connecting means 640 instead of the first connecting means 40. The cathode current collector 660 is different from the cathode current collector 60 in comprising no third through-hole 60h.

FIG. 14B is an exploded cross-sectional view schematically illustrating the position of the electrolysis element 600 in FIG. 14A, where the union of first structural elements 43 of the first connecting means 640, and the separating wall 610 is dissolved, and corresponds to FIG. 2B.

The separating wall 610 is different from the separating wall 10 in being provided with first threaded holes 610h, 610h, . . . (hereinafter may be simply referred to as “first threaded holes 610h”) instead of the first through-holes 10h, 10h, . . . . The first connecting means 640 is different from the first connecting means 40 (FIGS. 2A and 2B) in comprising first bolts 641, 641, . . . (hereinafter may be simply referred to as “first bolts 641”) instead of the first bolts 41, 41, . . . , and the first threaded holes 610h instead of the first through-holes 10h, but no first nut 42.

Each of the first bolts 641 is a bolt shorter than each of the first bolts 41 (FIGS. 2A and 2B). The first bolts 641 are different from the first bolts 41 in comprising shafts 641a each shorter than each of the shafts 41a, instead of the shafts 41a. The first threaded holes 610h provided in the separating wall 610 are threaded holes that can engage with the first bolts 641. The length of each of the shafts 641a of the first bolts 641 is preferably shorter than the total of the thickness of any of the first plate-shaped portions 43b and the depth of any of the first threaded holes 610h provided in the separating wall 610. As the material of the first bolts 641, the electroconductive material same as described above concerning the first bolts 41 may be used, and a preferred mode of the first bolts 641 is also as described above.

The anode 620 is different from the anode 20 (FIGS. 2A and 2B) in comprising fourth through-holes 620h, 620h, . . . (hereinafter may be simply referred to as “fourth through-holes 620h”) at positions facing the second through-holes 43bh provided in the first plate-shaped portions 43b of the first structural elements 43. The fourth through-holes 620h have shapes and dimensions such that the first bolts 641 can pass therethrough.

In the electrolysis element 600, the work of attaching the anode 620 to the separating wall 610 may be carried out by, for example, the steps of: (a) putting the shafts 641a of the first bolts 641 through the second through-holes 43bh provided in the first structural elements 43, which are joined to the anode 620; and (b) engaging the shafts 641a of the first bolts 641 with the first threaded holes 610h of the separating wall 610, in the order mentioned. The work of removing the anode 620 from the electrolysis element 600 may be carried out by, for example, the steps of: (c) inserting a jig or the like through the fourth through-holes 620h of the anode 620 to remove the first bolts 641 from the first threaded holes 610h of the separating wall 610; and (d) pulling to remove the anode 620, and the first structural elements 43 joined to the anode 620 from the separating wall 610, in the order mentioned. Such an electrolysis element 600 also allows easy work of replacing the anode 620, and thus, can reduce time and cost required for renewal of the anode 620. In the electrolysis element 600, the anode 620 is fixed to the separating wall 610 not by the engagement of the first bolts 41 with the first nuts 42, but by the engagement of the first bolts 641 with the first threaded holes 610h provided in the separating wall 610. Thus, any measures against the co-rotation of the first nuts with the first bolts are not necessary to be taken. Further, according to the electrolysis element 600, an electrolyte does not move between the anode chamber and the cathode chamber through any contact portions of the through-holes provided in the separating wall and the first bolts because the separating wall has the threaded holes but no through-hole.

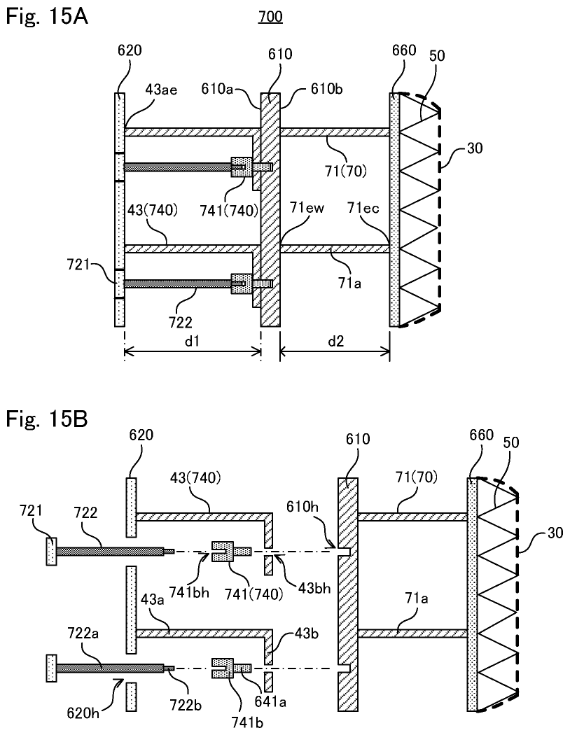

The electrolysis element 600 comprising the fourth through-holes 620h provided in the anode 620, which are not covered, has been described above concerning the present invention as an example. The present invention is not limited to this embodiment. For example, the electrolysis element may further comprise: second lid members comprising the same material as the anode 620 and covering at least part of the respective fourth through-holes 620h provided in the anode 620. FIG. 15A is a cross-sectional view schematically illustrating an electrolysis element 700 for alkaline water electrolysis according to such another embodiment (hereinafter may be referred to as “electrolysis element 700”), and corresponds to FIG. 14A. In FIGS. 15A and 15B, the elements already shown in FIGS. 2A to 14B are given the same reference signs as in FIGS. 2A to 14B, and the description thereof may be omitted. The electrolysis element 700 is different from the electrolysis element 600 (FIGS. 14A and 14B) in further comprising removable electroconductive second lid members 721, 721, . . . covering at least part of the respective fourth through-holes 620h, 620h, . . . of the anode 620 (hereinafter may be simply referred to as “second lid members 721”), and electroconductive second bolts 722 fixed to the second lid members 721, respectively; and in comprising a first connecting means 740 instead of the first connecting means 640. The first connecting means 740 is different from the first connecting means 640 in comprising first bolts 741, 741, . . . (hereinafter may be simply referred to as “first bolts 741”) instead of the first bolts 641, 641. . . .

FIG. 15B is an exploded cross-sectional view schematically illustrating the position of the electrolysis element 700 in FIG. 15A, where the union of the first structural elements 43 of the first connecting means 640, and the separating wall 610 is dissolved, and where the second lid members 721 are removed from the fourth through-holes 620h, and corresponds to FIG. 14B.

The second lid members 721 are made from the same material as the anode 620, and have shapes that enable the second lid members 721 to cover at least part of the respective fourth through-holes 620h of the anode 620 (for example, shapes corresponding to the fourth through-holes 620h). In the electrolysis element 700, the anode 620 and the second lid members 721 are rigid porous plates each including a rigid electroconductive base material made from an expanded metal, and the same catalyst supported on the surface of this electroconductive base material.

The second bolts 722 comprise extension shafts 722a protruding from the second lid members 721, and lid member fixing screws 722b provided at ends of the extension shafts 722a (ends on the side opposite to the second lid members 721). As the material of the second bolts 722, an alkali-resistant rigid electroconductive material may be used, and examples thereof include simple metals such as nickel and iron; stainless steel such as SUS304, SUS310, SUS310S, SUS316 and SUS316L; and metals obtained by nickeling any of them. Each of the extension shafts 722a and each of the lid member fixing screws 722b may be formed into one body. Each of the extension shafts 722a may be joined to each of the lid member fixing screws 722b by, for example, welding. For joining the second bolts 722 to the second lid members 721, any known means such as welding and brazing may be employed without particular limitations.

The first bolts 741 are different from the first bolts 641 in comprising heads 741b instead of the heads 641b. The heads 741b are different from the heads 641b in comprising second threaded holes 741bh that can engage with (the lid member fixing screws 722b of) the second bolts 722.

The second lid members 721 have shapes that enable the second lid members 721 to cover at least part of the respective fourth through-holes 620h of the anode 620 (for example, shapes corresponding to the fourth through-holes 620h), and can be put in the anode 620 to cover at least part of the respective fourth through-holes 620h. In the electrolysis element 700, (the lid member fixing screws 722b of) the second bolts 722 engage with the second threaded holes 741bh, and thereby, the second lid members 721 are removably fixed to the first bolts 741, cover at least part of the respective fourth through-holes 620h of the anode 620, and are electrically connected to the first bolts 741 via the second bolts 722. This causes the second lid members 721 to be electrically connected to the anode 620 via the second bolts 722, the first bolts 741, and the first structural elements 43.

The same effect as obtained from the above-described electrolysis element 600 (FIGS. 14A and 14B) can be also obtained from such an electrolysis element 700. Further, according to the electrolysis element 700 comprising the second lid members 721, the second lid members 721 compensate for the area of the anode, which is reduced by the fourth through-holes, which thus can ensure more uniformity of the current distribution, to further reduce energy loss.

The electrolysis element 700 comprising the second bolts 722 including the extension shafts 722a protruding from the second lid members 721, and the lid member fixing screws 722b provided at the ends of the extension shafts 722a has been described above concerning the present invention as an example. The present invention is not limited to this embodiment. For example, the electrolysis element may comprise a second bolt including the lid member fixing screw 722b directly fixed to the second lid member 721. For example, the electrolysis element may comprise a second bolt having the lid member fixing screw 722b, and a head which is provided at an end of the lid member fixing screw 722b and to which the second lid member 721 is fixed.

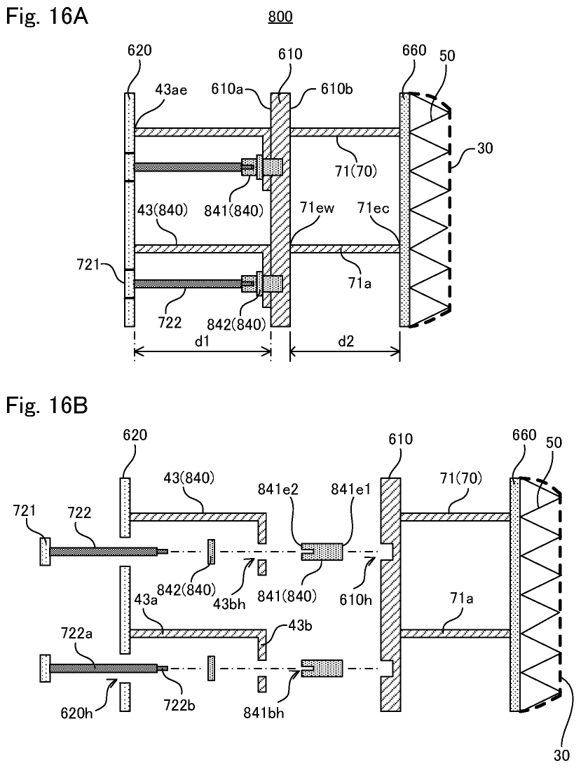

The electrolysis element 600 or 700 comprising the first bolts 641 or 741 including the heads 641b or 741b engaging with the first threaded holes 610h provided in the separating wall 610 has been described above concerning the present invention as an example. The present invention is not limited to this embodiment. For example, the electrolysis element may comprise a first bolt that is a stud bolt including no head. FIG. 16A is a cross-sectional view schematically illustrating an electrolysis element 800 for alkaline water electrolysis according to such another embodiment (hereinafter may be referred to as “electrolysis element 800”), and corresponds to FIG. 15A. In FIGS. 16A and 16B, the elements already shown in FIGS. 2A to 15B are given the same reference signs as in FIGS. 2A to 15B, and the description thereof may be omitted. The electrolysis element 800 is different from the electrolysis element 700 (FIGS. 15A and 15B) in comprising a first connecting means 840 instead of the first connecting means 740. The first connecting means 840 is different from the first connecting means 740 in comprising first bolts 841, 841, . . . that are stud bolts (hereinafter may be simply referred to as “first bolts 841” or “stud bolts 841”) instead of the first bolts 741, 741, . . . including the heads 741b, and in further comprising first nuts 842, 842, . . . that can engage with the first bolts 841, which are stud bolts (hereinafter may be simply referred to as “first nuts 842”). FIG. 16B is an exploded cross-sectional view schematically illustrating the position of the electrolysis element 800 in FIG. 16A, where the union of the first structural elements 43 of the first connecting means 840, and the separating wall 610 is dissolved, and where the union of the second lid members 721 and the first bolts 841, which are stud bolts, is dissolved, and corresponds to FIG. 15B.

The first bolts 841 are stud bolts, that is, bolts each provided with no head at an end of a shaft thereof. The stud bolts 841 each have a first end 841e1 and a second end 841e2. The stud bolts 841 are engaged with the first threaded holes 610h provided in the separating wall 610 from the first ends 841e1; thereby the first ends 841e1 of the stud bolts 841 are fixed to the separating wall 610. The stud bolts 841 fixed to the separating wall are put through the second through-holes 43bh provided in the first plate-shaped portions 43b of the first structural elements 43 to engage with the first nuts 842 from the second ends 841e2; thereby the first structural elements 43 are fixed to the separating wall 610. An electroconductive material described above concerning the first bolts 41 and the first nuts 42 may be used as the material of the stud bolts 841 and the first nuts 842. Preferred modes of the stud bolts 841 and the first nuts 842 are also as described above.

Second threaded holes 841bh that can engage with (the lid member fixing screws 722b of) the second bolts 722 are provided in the second ends 841e2 of the stud bolts 841. The second bolts 722 are engaged with the second threaded holes 841bh, and thereby, the second lid members 721 are removably fixed to the stud bolts 841 by means of the second bolts 722, cover at least part of the respective fourth through-holes 620h of the anode 620, and are electrically connected to the stud bolts 841. This causes the second lid members 721 to be electrically connected to the anode 620 via the second bolts 722, the stud bolts 841, the first nuts 842, and the first structural elements 43.

The same effect as obtained from the above-described electrolysis element 700 can be also obtained from such an electrolysis element 800.

The electrolysis element 800 comprising the second bolts 722 including the extension shafts 722a protruding from the second lid members 721, and the lid member fixing screws 722b provided at the ends of the extension shafts 722a has been described above concerning the present invention as an example. The present invention is not limited to this embodiment. For example, the electrolysis element may comprise a second bolt including the lid member fixing screw 722b directly fixed to the second lid member 721. For example, the electrolysis element may comprise a second bolt having the lid member fixing screw 722b, and a head which is provided at the end of the lid member fixing screw 722b, and to which the second lid member 721 is fixed. For example, the electrolysis element may comprise no second lid member 721 or second bolt 722.

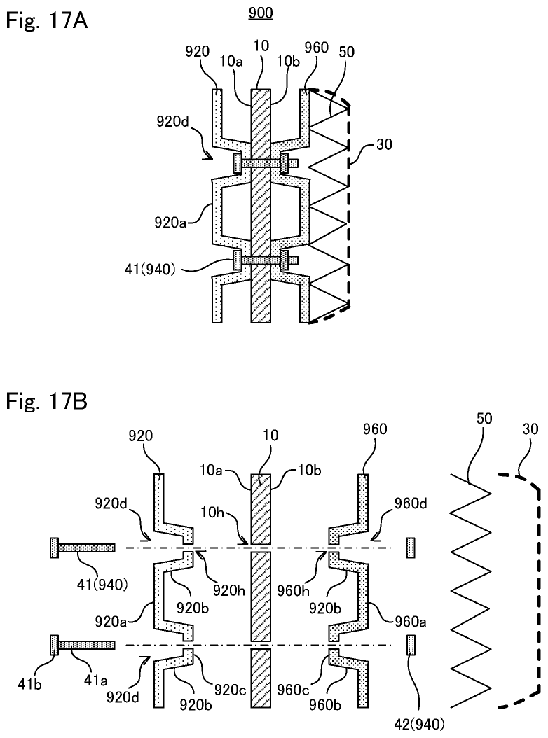

The electrolysis elements 100, 200, 300, 400, 500, 600, 700 and 800 each comprising the first bolts with which the anode is fixed to the separating wall have been described above concerning the present invention as an example. The present invention is not limited to this embodiment. For example, the electrolysis element may comprise one bolt with which both the anode and the cathode current collector are fixed to the separating wall. FIG. 17A is a cross-sectional view schematically illustrating an electrolysis element 900 for alkaline water electrolysis according to such another embodiment (hereinafter may be referred to as “electrolysis element 900”), and corresponds to FIG. 2A. In FIGS. 17A and 17B, the elements already shown in FIGS. 2A to 16B are given the same reference signs as in FIGS. 2A to 16B, and the description thereof may be omitted. The electrolysis element 900 is different from the electrolysis element 100 (FIGS. 2A and 2B) in comprising an anode 920 instead of the anode 20, a cathode current collector 960 instead of the cathode current collector 60, and a third connecting means 940 instead of the first connecting means 40 and the second connecting means 70. FIG. 17B is an exploded cross-sectional view schematically illustrating the position of the electrolysis element 900 in FIG. 17A, where the union of the anode 920, the separating wall 10 and the cathode current collector 960 is dissolved, and corresponds to FIG. 2B.

The third connecting means 940 includes the first bolts 41, 41, . . . , the first through-holes 10h, 10h, . . . , which are provided in the separating wall 10 and through which the shafts 41a of the first bolts 41 can be put, and the first nuts 42, 42, . . . that can engage with the first bolts 41. The third connecting means fixes the anode 920 and the cathode current collector 960 to the separating wall 10 and electrically connects the anode 920 and the cathode current collector 960, such that the anode 920 faces the first face 10a of the separating wall 10 and the cathode current collector 960 faces the second face 10b of the separating wall 10.

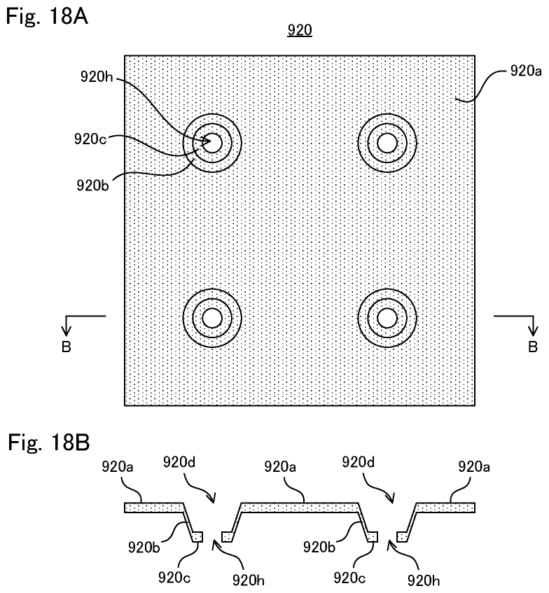

FIG. 18A is a plan view schematically illustrating the anode 920. FIG. 18B is a cross-sectional view taken along the line B-B in FIG. 18A. As shown in FIGS. 18A and 18B, the anode 920 comprises: a first flat portion 920a extending two-dimensionally; first cup-shaped portions 920b, 920b, . . . protruding from the first flat portion 920a toward the first face 10a of the separating wall 10 and being tapered (hereinafter may be simply referred to as “first cup-shaped portions 920b”); and fifth through-holes 920h provided in respective bottom portions 920c of the first cup-shaped portions 920b, through which the shafts 41a of the first bolts 41 can be put. As can be understood from FIGS. 17A, 17B and 18B, the anode 920 has openings 920d, 920d, . . . corresponding to the first cup-shaped portions 920b, 920b, . . . (hereinafter may be simply referred to as “openings 920d”). As the material of the anode 920, the electroconductive base material and the catalyst which are the same as the material of the above-described anode 20 (FIGS. 2A and 2B) may be used, and a preferred mode of the anode 920 is also the same as described above. In the electrolysis element 900, for example, an anode including: a rigid electroconductive base material that is shaped correspondingly to the first cup-shaped portions 920b and the fifth through-holes 920h by, for example, pressing and stamping, and that is made from an expanded metal; and a catalyst supported on the surface of this electroconductive base material may be used as the anode 920.

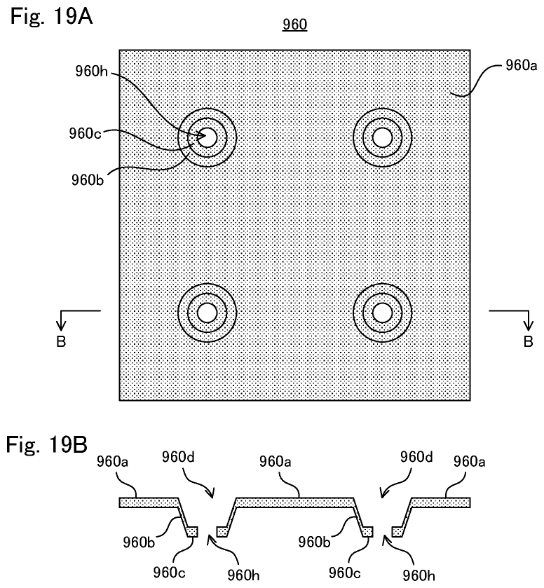

FIG. 19A is a plan view schematically illustrating the cathode current collector 960. FIG. 19B is a cross-sectional view taken along the line B-B in FIG. 19A. As shown in FIGS. 19A and 19B, the cathode current collector 960 comprises: a second flat portion 960a extending two-dimensionally; second cup-shaped portions 960b, 960b, . . . protruding from the second flat portion 960a toward the second face 10b of the separating wall 10 and being tapered (hereinafter may be simply referred to as “second cup-shaped portions 960b”); and sixth through-holes 960h provided in respective bottom portions 960c of the second cup-shaped portions 960b, through which the shafts 41a of the first bolts 41 can be put. As can be understood from FIGS. 17A, 17B and 19B, the cathode current collector 960 has openings 960d, 960d, . . . corresponding to the second cup-shaped portions 960b, 960b, . . . (hereinafter may be simply referred to as “openings 960d”). As the material of the cathode current collector 960, the rigid electroconductive material same as the material of the above-described cathode current collector 60 (FIGS. 2A and 2B) may be used, and a preferred mode of the cathode current collector 960 is also the same as described above. In the electrolysis element 900, for example, a rigid cathode current collector that is given the second cup-shaped portions 960b and the sixth through-holes 960h by, for example, pressing and stamping, and that is made from an expanded metal may be used as the cathode current collector 960.

FIGS. 17A and 17B will be referred to again. In the electrolysis element 900, the shafts 41a of the first bolts 41 are put through the first through-holes 10h of the separating wall 10, the fifth through-holes 920h of the anode 920, and the sixth through-holes 960h of the cathode current collector 960, to engage with the first nuts 42, and thereby, the heads 41b of the first bolts 41 and the first nuts 42 sandwich and fasten the anode 920, the separating wall 10 and the cathode current collector 960. This causes the anode 920 and the cathode current collector 960 to be removably fixed to the separating wall 10 by means of the first bolts 41 and the first nuts 42. Attending this, the anode 920, the cathode current collector 960 and the separating wall 10 are electrically connected via the first bolts 41 and the first nuts 42.

In the electrolysis element 900, the work of attaching the anode 920 and the cathode current collector 960 to the separating wall 10 may be carried out by, for example, the steps of: (a) putting the shafts 41a of the first bolts 41 through the fifth through-holes 920h of the anode 920; (b) further putting the shafts 41a of the first bolts 41 through the through-holes 10h of the separating wall 10; (c) further putting the shafts 41a of the first bolts 41 through the sixth through-holes 960h of the cathode current collector 960; and (d) engaging the shafts 41a of the first bolts 41 with the first nuts 42, in the order mentioned. The work of removing the anode 920 and the cathode current collector 960 from the electrolysis element 900 may be carried out by, for example, the steps of: (e) removing the cathode 30 and the elastic body 50 from the cathode current collector 960; (f) removing the first nuts 42 from the shafts 41a of the first bolts 41; (g) pulling and removing the anode 920 from the separating wall 10; and (h) pulling out the shafts 41a of the first bolts 41 from the fifth through-holes 920h of the anode 920, the first through-holes 10h of the separating wall 10, and the sixth through-holes 960h of the cathode current collector 960. Like this, the electrolysis element 900 also allows easy work of replacing the anode 920, and thus, can reduce time and cost required for renewal of the anode 920.

The electrolysis element 900 comprising the first bolts 41 put through the fifth through-holes 920h, the first through-holes 10h and the sixth through-holes 960h from the side of the anode 920, to engage with the first nuts 42 on the side of the cathode current collector 960 has been described above concerning the present invention as an example. The present invention is not limited to this embodiment. For example, the electrolysis element may comprise the first bolts 41 put through the sixth through-holes 960h, the first through-holes 10h and the fifth through-holes 920h from the side of the cathode current collector 960, to engage with the first nuts 42 on the side of the anode 920.

The electrolysis element 900 wherein the anode 920 and the cathode current collector 960 are removably fixed to the separating wall 10 by means of the first bolts 41 and the first nuts 42, and attending this, the anode 920, the cathode current collector 960, and the separating wall 10 are electrically connected via the first bolts 41 and the first nuts 42 has been described above concerning the present invention as an example. The present invention is not limited to this embodiment. For example, such an electrolysis element may be encompassed that the anode 920 and the cathode current collector 960 are removably fixed to the separating wall 10 by means of the first bolts 41 and the first nuts 42, and attending this, the anode 920 and the cathode current collector 960 are electrically connected via the first bolts 41 and the first nuts 42, but the separating wall 10 is not electrically connected to the anode 920 or the cathode current collector 960. The electrolysis element 900 comprising the electroconductive separating wall 10 has been described above concerning the present invention as an example. The present invention is not limited to this embodiment. For example, the electrolysis element may comprise a separating wall that is not electroconductive instead of the electroconductive separating wall 10, wherein the anode 920 and the cathode current collector 960 are removably fixed to the separating wall that is not electroconductive by means of the first bolts 41 and the first nuts 42, and attending this, the anode 920 and the cathode current collector 960 are electrically connected via the first bolts 41 and the first nuts 42. The forgoing are because the function as an electrolysis element is exercised as long as the anode and the cathode current collector that are arranged with the separating wall therebetween are electrically connected even when the separating wall is not electroconductive. An alkali-resistant resin material having strength with which the anode and the cathode current collector can be supported may be preferably used as the material of such a separating wall that is not electroconductive. Preferred examples of such a resin material include rigid polyvinyl chloride resins, polypropylene resins, polyethylene resins, polyetherimide resins, polyphenylenesulfide resins, polybenzimidazole resins, polytetrafluoroethylene resins, tetrafluoroethylene-perfluoroalkyl vinyl ether copolymer resins, and tetrafluoroethylene-ethylene copolymer resins.

The electrolysis element 900 comprising the anode 920 including the four fifth through-holes 920h corresponding to the first cup-shaped portions 920b in number, the cathode current collector 960 including the four sixth through-holes 960h corresponding to the second cup-shaped portions 960b in number, and the separating wall 10 including the four first through-holes 10h has been described above concerning the present invention as an example. The present invention is not limited to this embodiment. The following are freely selected as long as the anode and the cathode current collector can be removably fixed to the separating wall by means of the first bolt(s): the numbers of the fifth through-holes provided in the anode, the sixth through-holes provided in the cathode current collector, and the first through-holes provided in the separating wall; and the shapes and the arrangement of the first cup-shaped portions provided correspondingly to them in the anode, and the second cup-shaped portions provided correspondingly to them in the cathode current collector. It is noted that when the arrangement of the first through-holes is determined, the arrangement of the first cup-shaped portions and the second cup-shaped portions is determined correspondingly to this because the fifth through-holes, the sixth through-holes and the first through-holes are provided at corresponding positions.

The electrolysis element 900 comprising the openings 960d, which correspond to the second cup-shaped portions 960b of the cathode current collector 960 and which are not covered, has been described above concerning the present invention as an example. The present invention is not limited to this embodiment. For example, the electrolysis element may further comprise first lid members covering at least part of the respective openings 960d of the cathode current collector 960. Such first lid members can be put to cover at least part of the respective openings 960d corresponding to the second cup-shaped portions 960b to be electrically connected to the cathode current collector 960 in the same manner as, for example, the first lid members 61 described above concerning the electrolysis element 200, or the first lid members 361 described above concerning the electrolysis element 300.

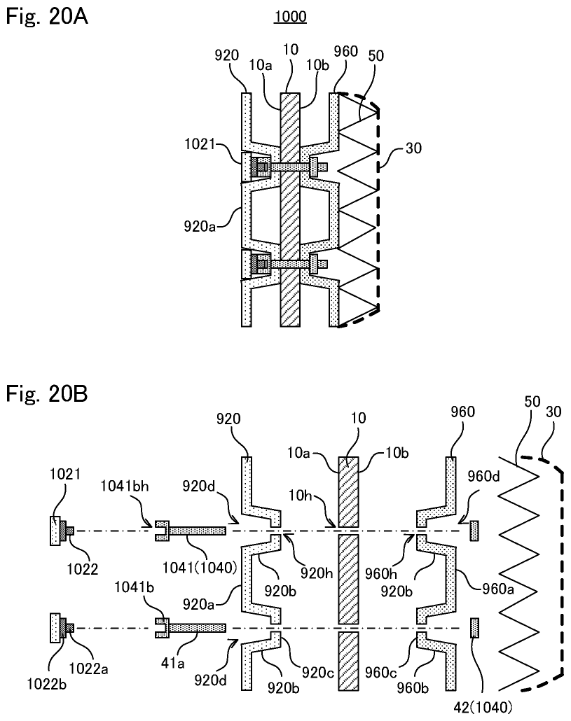

The electrolysis element 900 comprising the openings 920d, which correspond to the first cup-shaped portions 920b of the anode 920 and which are not covered, has been described above concerning the present invention as an example. The present invention is not limited to this embodiment. For example, the electrolysis element may further comprise second lid members covering at least part of the respective openings 920d of the anode 920. FIG. 20A is a cross-sectional view schematically illustrating an electrolysis element 1000 for alkaline water electrolysis according to such another embodiment (hereinafter may be referred to as “electrolysis element 1000”), and corresponds to FIG. 17A. In FIGS. 20A and 20B, the elements already shown in FIGS. 2A to 19B are given the same reference signs as in FIGS. 2A to 19B, and the description thereof may be omitted. The electrolysis element 1000 is different from the electrolysis element 900 (FIGS. 17A and 17B) in further comprising removable second lid members 1021, 1021, . . . comprising the same material as the anode 920 and covering at least part of the respective openings 920d, 920d, . . . of the first cup-shaped portions 920b, 920b, . . . of the anode 920 (hereinafter may be simply referred to as “second lid members 1021”), and electroconductive second bolts 1022 fixed to the respective second lid members 1021, and in comprising a third connecting means 1040 instead of the third connecting means 940. The third connecting means 1040 is different from the third connecting means 940 in comprising first bolts 1041, 1041, . . . (hereinafter may be referred to as “first bolts 1041”) instead of the first bolts 41, 41, . . . . The first bolts 1041 are different from the first bolts 41 in comprising heads 1041b instead of the heads 41b. FIG. 20B is an exploded cross-sectional view schematically illustrating the position of the electrolysis element 1000 in FIG. 20A, where the union of the anode 920, the separating wall 10 and the cathode current collector 960 is dissolved, and where the second lid members 1021 are removed from the openings 920d of the first cup-shaped portions 920b, and corresponds to FIG. 17B.

The second lid members 1021 comprise the same material as the anode 920 and have shapes extending two-dimensionally such that the second lid members can cover at least part of the respective openings 920d of the first cup-shaped portions 920b of the anode 920 (for example, corresponding to the shapes of the openings 920d). In the electrolysis element 1000, the anode 920 and the second lid members 1021 are rigid porous plates each including a rigid electroconductive base material made from an expanded metal, and the same catalyst supported on the surface of this electroconductive base material. Among them, the second lid members 1021 have disc-liked shapes correspondingly to the openings 920d of the first cup-shaped portions 920b of the anode 920 (see FIGS. 18A and 18B).

The second bolts 1022 are electroconductive bolts having heads 1022b fixed to the second lid members 1021, and shafts 1022a fixed to the heads 1022b. As the material of the second bolts 1022, an alkali-resistant rigid electroconductive material may be used, and examples thereof include simple metals such as nickel and iron; stainless steel such as SUS304, SUS310, SUS310S, SUS316 and SUS316L; and metals obtained by nickeling any of them. For joining the heads 1022b of the second bolts 1022 to the second lid members 1021, any known means such as welding and brazing may be employed without particular limitations.

The first bolts 1041 are different from the first bolts 41 in comprising the heads 1041b instead of the heads 41b (see FIGS. 2A, 2B, 17A and 17B). The heads 1041b of the first bolts 1041 are different from the heads 41b of the first bolts 41 in comprising threaded holes 1041bh that can engage with (the shafts 1022a of) the second bolts 1022.

In the electrolysis element 1000, (the shafts 1022a of) the second bolts 1022 fixed to the second lid members 1021 are engaged with the threaded holes 1041bh of the heads of the first bolts 1041, and thereby, the second lid members 1021 are removably fixed to the first bolts 1041, and cover at least part of the respective openings 920d of the first cup-shaped portions 920b of the anode 920. Attending this, the second lid members 1021 are electrically connected to the anode 920 via the second bolts 1022 and the first bolts 1041.

The same effect as obtained from the above-described electrolysis element 900 (FIGS. 17A and 17B) can be also obtained from such an electrolysis element 1000. Further, according to the electrolysis element 1000 comprising the second lid members 1021, the second lid members 1021 compensate for the area of the anode, which is reduced by the openings 920d of the first cup-shaped portions 920b, which thus can ensure more uniformity of the current distribution, to further reduce energy loss.

The electrolysis element 1000 wherein the anode 920 and the cathode current collector 960 are removably fixed to the separating wall 10 by means of the first bolts 1041 and the first nuts 42, and attending this, the anode 920, the cathode current collector 960 and the separating wall 10 are electrically connected via the first bolts 1041 and the first nuts 42 has been described above concerning the present invention as an example. The present invention is not limited to this embodiment. For example, such an electrolysis element may be encompassed that the anode 920 and the cathode current collector 960 are removably fixed to the separating wall 10 by means of the first bolts 1041 and the first nuts 42, and attending this, the anode 920 and the cathode current collector 960 are electrically connected via the first bolts 1041 and the first nuts 42, but the separating wall 10 is not electrically connected to the anode 920 or the cathode current collector 960. The electrolysis element 1000 comprising the electroconductive separating wall 10 has been described above concerning the present invention as an example. The present invention is not limited to this embodiment. For example, the electrolysis element may comprise a separating wall that is not electroconductive instead of the electroconductive separating wall 10, wherein the anode 920 and the cathode current collector 960 are removably fixed to the separating wall that is not electroconductive by means of the first bolts 1041 and the first nuts 42, and attending this, the anode 920 and the cathode current collector 960 are electrically connected via the first bolts 1041 and the first nuts 42. The forgoing are because the function as an electrolysis element is exercised as long as the anode and the cathode current collector that are arranged with the separating wall therebetween are electrically connected even when the separating wall is not electroconductive. An alkali-resistant resin material having strength with which the anode and the cathode current collector can be supported may be preferably used as the material of such a separating wall that is not electroconductive. Preferred examples of such a resin material include rigid polyvinyl chloride resins, polypropylene resins, polyethylene resins, polyetherimide resins, polyphenylenesulfide resins, polybenzimidazole resins, polytetrafluoroethylene resins, tetrafluoroethylene-perfluoroalkyl vinyl ether copolymer resins, and tetrafluoroethylene-ethylene copolymer resins.

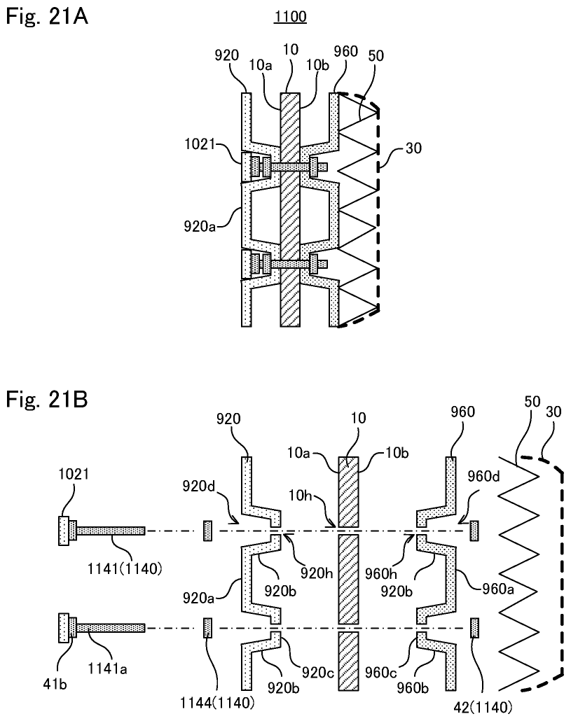

The electrolysis element 900 or 1000 wherein the heads of the first bolts 41 or 1041 and the first nuts 42 sandwich and fasten the anode 920, the separating wall 10 and the cathode current collector 960 have been described above concerning the present invention as an example. The present invention is not limited to this embodiment. For example, the electrolysis element may comprise two nuts engaging with the one same bolt which sandwich and fasten the anode 920, the separating wall 10 and the cathode current collector 960. FIG. 21A is a cross-sectional view schematically illustrating an electrolysis element 1100 for alkaline water electrolysis according to such another embodiment (hereinafter may be referred to as “electrolysis element 1100”), and corresponds to FIGS. 17A and 20A. In FIGS. 21A and 21B, the elements already shown in FIGS. 2A to 20B are given the same reference signs as in FIGS. 2A to 20B, and the description thereof may be omitted. The electrolysis element 1100 is different from the electrolysis element 1000 (FIGS. 20A and 20B) in comprising no electroconductive second bolt 1022 fixed to the second lid member 1021, but comprising a third connecting means 1140 instead of the third connecting means 1040. The third connecting means 1140 is different from the third connecting means 1040 in comprising first bolts 1141, 1141, . . . (hereinafter may be simply referred to as “first bolts 1141”) instead of the first bolts 1041, 1041, . . . ; and further comprising second nuts 1144, 1144, . . . (hereinafter may be simply referred to as “second nuts 1144”) that can engage with the first bolts 1141, 1141, . . . . FIG. 21B is an exploded cross-sectional view schematically illustrating the position of the electrolysis element 1100 in FIG. 20A, where the union of the anode 920, the separating wall 10 and the cathode current collector 960 is dissolved, and where the second lid members 1021 are removed from the openings 920d of the first cup-shaped portions 920b, and corresponds to FIGS. 17B and 20B.

The first bolts 1141 are different from the first bolts 41 in comprising shafts 1141a each longer than each of the shafts 41a, instead of the shafts 41a. As the material of the first bolts 1141, the electroconductive material same as the above-described material of the first bolts 41 (FIGS. 2A and 2B) may be used, and a preferred mode of the first bolts 1141 is also as described above. The electroconductive nuts same as the first nuts 42 may be used as the second nuts 1144. The first bolts 1141 each comprise a shaft 1141a, and the head 41b provided at an end of the shaft 1141a. The second lid members 1021 are fixed to the heads 41b of the first bolts 1141, and electrically connected to the first bolts 1141.

In the electrolysis element 1100, the shafts 1141a of the first bolts 1141 engaging with the second nuts 1144 are put through the fifth through-holes 920h of the anode 920, the first through-holes 10h of the separating wall 10, and the sixth through-holes 960h of the cathode current collector 960, to engage with the first nuts 42, and thereby, the first nuts 42 and the second nuts 1144 sandwich and fasten the anode 920, the separating wall 10 and the cathode current collector 960. This causes the anode 920, the second lid members 1021 and the cathode current collector 960 to be removably fixed to the separating wall 10 by means of the first bolts 1141, the first nuts 42 and the second nuts 1144; and the second lid members 1021 to cover at least part of the respective openings 920d of the first cup-shaped portions 920b of the anode 920. Attending to this, the anode 920, the cathode current collector 960 and the separating wall 10 are electrically connected via the first bolts 1141, the first nuts 42 and the second nuts 1144; and the second lid members 1021 are electrically connected to the anode 920 via the first bolts 1141 and the second nuts 1144.

The same effect as obtained from the above-described electrolysis element 900 (FIGS. 17A and 17B) can be also obtained from such an electrolysis element 1100. Further, according to the electrolysis element 1100 comprising the second lid members 1021, the second lid members 1021 compensate for the area of the anode, which is reduced by the openings 920d of the first cup-shaped portions 920b, which thus can ensure more uniformity of the current distribution, to further reduce energy loss.

The electrolysis element 1100 wherein the anode 920 and the cathode current collector 960 are removably fixed to the separating wall 10 by means of the first bolts 1141, the first nuts 42 and the second nuts 1144, and attending this, the anode 920, the cathode current collector 960 and the separating wall 10 are electrically connected via the first bolts 1141 and the first nuts 42 has been described above concerning the present invention as an example. The present invention is not limited to this embodiment. For example, such an electrolysis element may be encompassed that the anode 920 and the cathode current collector 960 are removably fixed to the separating wall 10 by means of the first bolts 1141, the first nuts 42 and the second nuts 1144, and attending this, the anode 920 and the cathode current collector 960 are electrically connected via the first bolts 1141, the first nuts 42 and the second nuts 1144, but the separating wall 10 is not electrically connected to the anode 920 or the cathode current collector 960. The electrolysis element 1100 comprising the electroconductive separating wall 10 has been described above concerning the present invention as an example. The present invention is not limited to this embodiment. For example, the electrolysis element may comprise a separating wall that is not electroconductive instead of the electroconductive separating wall 10, wherein the anode 920 and the cathode current collector 960 are removably fixed to the separating wall that is not electroconductive by means of the first bolts 1141, the first nuts 42 and the second nuts 1144, and attending this, the anode 920 and the cathode current collector 960 are electrically connected via the first bolts 1141, the first nuts 42 and the second nuts 1144. The foregoing are because the function as an electrolysis element is exercised as long as the anode and the cathode current collector that are arranged with the separating wall therebetween are electrically connected even when the separating wall is not electroconductive. An alkali-resistant resin material having strength with which the anode and the cathode current collector can be supported may be preferably used as the material of such a separating wall that is not electroconductive. Preferred examples of such a resin material include rigid polyvinyl chloride resins, polypropylene resins, polyethylene resins, polyetherimide resins, polyphenylenesulfide resins, polybenzimidazole resins, polytetrafluoroethylene resins, tetrafluoroethylene-perfluoroalkyl vinyl ether copolymer resins, and tetrafluoroethylene-ethylene copolymer resins.

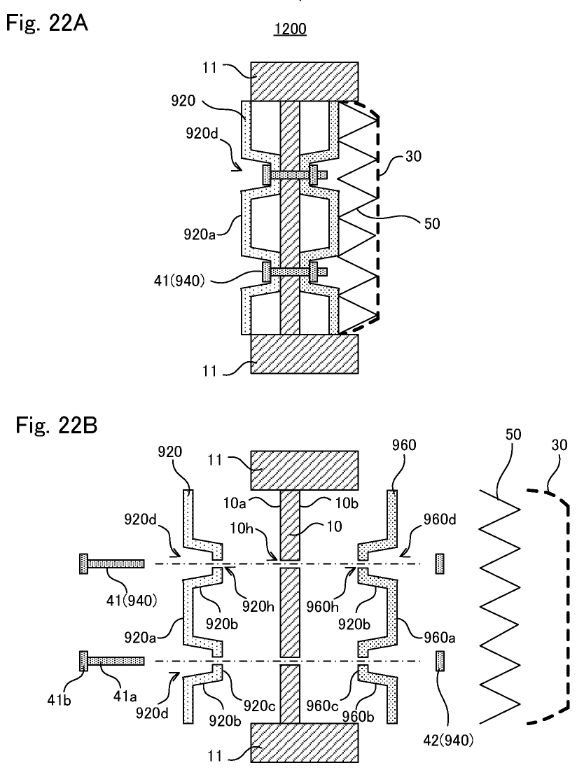

The electrolysis elements 100, 200, 300, 400, 500, 600, 700, 800, 900, 1000 and 1100 each provided with no flange portion at the periphery of the separating wall has been described above concerning the present invention as an example. The present invention is not limited to this embodiment. For example, the electrolysis element may further comprise a flange portion arranged at the periphery of the separating wall. FIG. 22A is a cross-sectional view schematically illustrating an electrolysis element 1200 for alkaline water electrolysis according to such another embodiment (hereinafter may be referred to as “electrolysis element 1200”), and corresponds to FIG. 17A. In FIGS. 22A and 22B, the elements already shown in FIGS. 2A to 21B are given the same reference signs as in FIGS. 2A to 21B, and the description thereof may be omitted. The electrolysis element 1200 is different from the electrolysis element 900 (FIGS. 17A and 17B) in further comprising: a flange portion 11 being arranged at the periphery of the separating wall 10 and extending toward both sides of the separating wall 10 in a direction crossing the first face 10a and the second face 10b of the separating wall 10.

The flange portion 11 unites with the periphery of the separating wall 10 with watertightness. The flange portion 11 is provided with: an anolyte supply flow path adapted to supply an anolyte to the anode chamber, where the anode 920 is arranged; an anolyte collection flow path adapted to collect, from the anode chamber, the anolyte, and gas generated at the anode; a catholyte supply flow path adapted to supply a catholyte to the cathode chamber, where the cathode 30 is arranged; and a catholyte collection flow path adapted to collect, from the cathode chamber, the catholyte, and gas generated at the cathode, which are not shown in FIGS. 22A and 22B. An alkali-resistant rigid material may be used as the material of the flange portion 11 without particular limitations. Examples of such a material include simple metals such as nickel and iron; stainless steel such as SUS304, SUS310, SUS310S SUS316, and SUS316L; metal materials obtained by nickeling any of them; and non-metal materials such as reinforced plastics. The separating wall 10 and the flange portion 11 may be joined to each other by welding, adhesion, or the like, and may be formed of the same material into one body.

FIG. 22B is an exploded cross-sectional view schematically illustrating the position of the electrolysis element 1200 in FIG. 22A, where the union of the anode 920, the separating wall 10 and the cathode current collector 960 is dissolved, and corresponds to FIG. 17B. The electrolysis element 1200 comprising the flange portion 11 also allows easy work of replacing the anode 920 as the above-described electrolysis element 900 (FIGS. 17A and 17B), and thus, can reduce time and cost required for renewal of the anode 920.

The electrolysis element 1200 further comprising the flange portion 11 at the periphery of the separating wall 10 of the electrolysis element 900 (FIGS. 17A and 17B) has been described above concerning the present invention as an example. The present invention is not limited to this embodiment. For example, the electrolysis element may further comprise the flange portion at the periphery of the separating wall 10 or 610 of the above-described electrolysis element 100 (FIGS. 2A and 2B), 200 (FIGS. 4A and 4B), 300 (FIGS. 7A and 7B), 400 (FIGS. 8A and 8B), 500 (FIGS. 12A and 12B), 600 (FIGS. 14A and 14B), 700 (FIGS. 15A and 15B), 800 (FIGS. 16A and 16B), 1000 (FIGS. 20A and 20B), or 1100 (FIGS. 21A and 21B).

The electrolysis element 1200 wherein the anode 920 and the cathode current collector 960 are removably fixed to the separating wall 10 by means of the first bolts 41 and the first nuts 42, and attending this, the anode 920, the cathode current collector 960 and the separating wall 10 are electrically connected via the first bolts 41 and the first nuts 42 has been described above concerning the present invention as an example. The present invention is not limited to this embodiment. For example, such an electrolysis element may be encompassed that the anode 920 and the cathode current collector 960 are removably fixed to the separating wall 10 by means of the first bolts 41 and the first nuts 42, and attending this, the anode 920 and the cathode current collector 960 are electrically connected via the first bolts 41 and the first nuts 42, but the separating wall 10 is not electrically connected to the anode 920 or the cathode current collector 960. The electrolysis element 1200 comprising the electroconductive separating wall 10 has been described above concerning the present invention as an example. The present invention is not limited to this embodiment. For example, the electrolysis element may comprise a separating wall that is not electroconductive instead of the electroconductive separating wall 10, wherein the anode 920 and the cathode current collector 960 are removably fixed to the separating wall that is not electroconductive by means of the first bolts 41 and the first nuts 42, and attending this, the anode 920 and the cathode current collector 960 are electrically connected via the first bolts 41 and the first nuts 42. The forgoing are because the function as an electrolysis element is exercised as long as the anode and the cathode current collector that are arranged with the separating wall therebetween are electrically connected even when the separating wall is not electroconductive. An alkali-resistant resin material having strength with which the anode and the cathode current collector can be supported may be preferably used as the material of such a separating wall that is not electroconductive. Preferred examples of such a resin material include rigid polyvinyl chloride resins, polypropylene resins, polyethylene resins, polyetherimide resins, polyphenylenesulfide resins, polybenzimidazole resins, polytetrafluoroethylene resins, tetrafluoroethylene-perfluoroalkyl vinyl ether copolymer resins, and tetrafluoroethylene-ethylene copolymer resins.

<2. Alkaline Water Electrolysis Vessel>

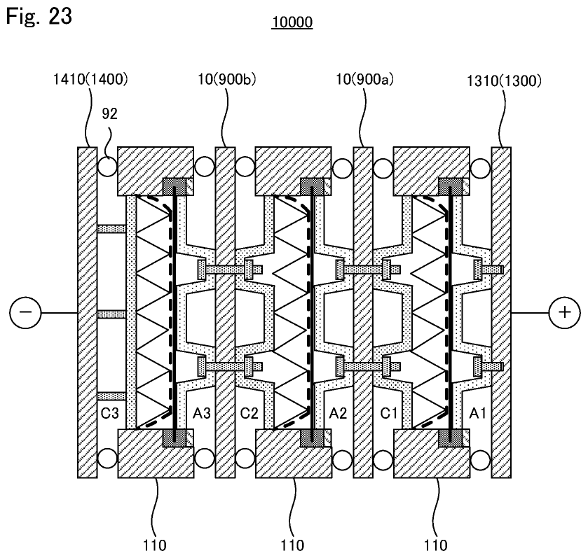

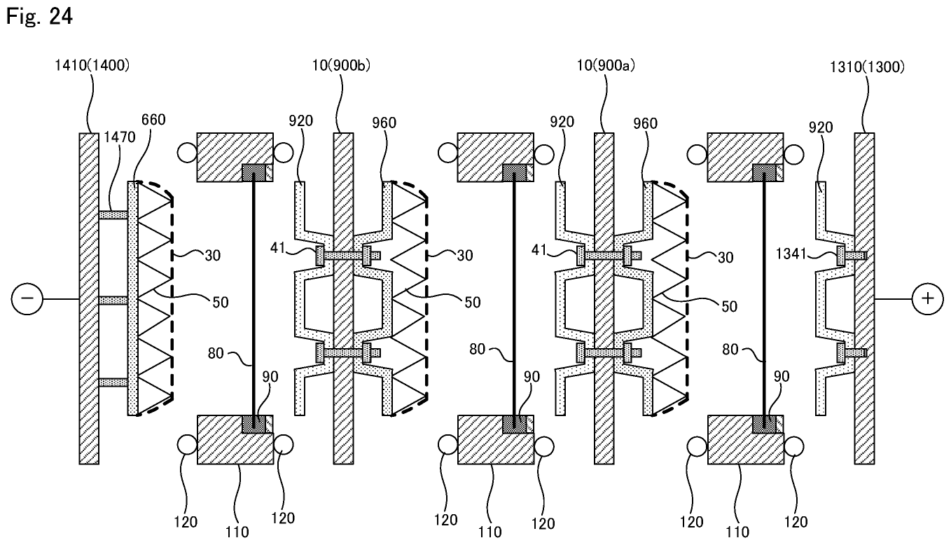

FIG. 23 is a cross-sectional view schematically illustrating an alkaline water electrolysis vessel 10000 according to one embodiment (hereinafter may be referred to as “electrolysis vessel 10000”). FIG. 24 is an exploded view of FIG. 23. In FIGS. 23 and 24, the elements already shown in FIGS. 2A to 22B are given the same reference signs as in FIGS. 2A to 22B, and the description thereof may be omitted. The electrolysis vessel 10000 comprises a stack structure comprising: a plurality of ion-permeable separating membranes 80, 80, . . . (hereinafter may be simply referred to as “separating membranes 80”); and the electrolysis elements 900, 900, . . . each arranged between each adjacent pair of the separating membranes 80, 80 (FIGS. 17A and 17B). Each adjacent pair of the electrolysis elements 900, 900 is arranged so that the anode 920 of one of the electrolysis elements 900 and the cathode 30 of the other electrolysis element 900 face each other sandwiching the separating membrane 80 therebetween. The electrolysis vessel 10000 further comprises a first terminal element 1300 and a second terminal element 1400. The first terminal element 1300 is arranged facing the cathode 30 of a first electrolysis element 900a arranged at one end of the stack structure, such that the first terminal element 1300 and the cathode 30 of the first electrolysis element 900a sandwich the separating membrane 80 therebetween. The second terminal element 1400 is arranged facing the anode 920 of a second electrolysis element 900b arranged at the other end of the stack structure, such that the second terminal element 1400 and the anode 920 of the second electrolysis element 900b sandwich the separating membrane 80 therebetween. The first terminal element 1300 comprises: an electroconductive first separating wall 1310; and a first anode 920 electrically connected to the first separating wall 1310. The second terminal element 1400 comprises: an electroconductive second separating wall 1410; and a second cathode 30 electrically connected to the second separating wall 1410.

The electrolysis vessel 10000 further comprises: gaskets 90, 90, . . . each holding each periphery of the separating membranes 80 (hereinafter may be simply referred to as “gaskets 90”); insulating frame-shaped protecting members 110 each holding each periphery of the separating membranes 80 as the gaskets 90 each being present between each of the protecting members 110 and each of the separating membranes 80; and sealing members 120 each arranged among the separating walls 10 and the protecting members 110, between the first separating wall 1310 and the protecting member 110, and between the second separating wall 1410 and the protecting member 110.

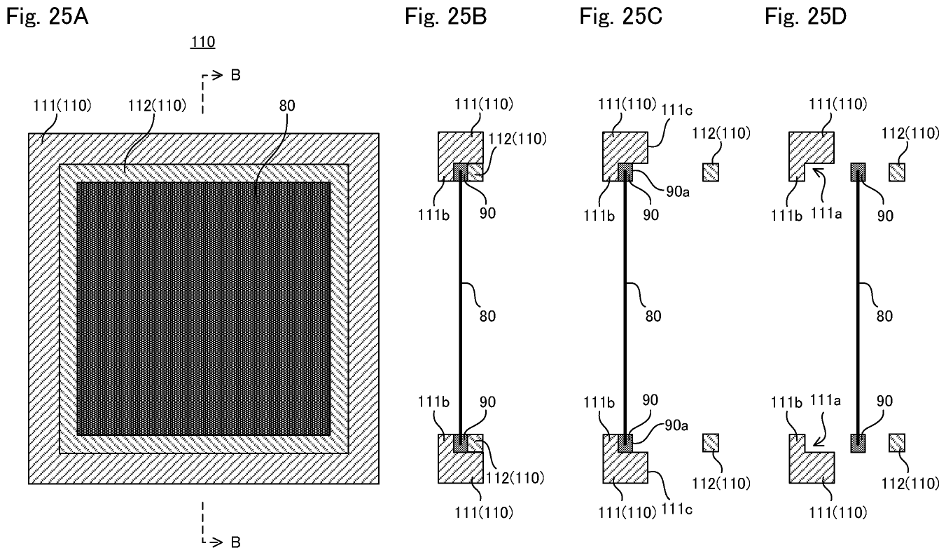

FIG. 25A is a plan view schematically illustrating one of the protecting members 110 holding the separating membrane 80 and the gasket 90. FIG. 25B is a cross-sectional view in the direction indicated by the arrow B-B of FIG. 25A. FIGS. 25C and 25D are cross-sectional views showing the position where the protecting member 110 is exploded in FIG. 25B. In FIGS. 25A to 25D, the elements already shown in FIGS. 2A to 24 are given the same reference signs as in FIGS. 2A to 24, and the description thereof may be omitted. As described above, the periphery of the separating membrane 80 is held by the gasket 90, and the gasket 90 is held by the frame-shaped protecting member 110. The protecting member 110 comprises a frame-shaped base body 111, and a frame-shaped lid member 112. The base body 111 includes: a receiving part 111a arranged on the inner periphery side of the base body 111 and receiving the gasket 90 (which holds the separating membrane 80) and the lid member 112; and a supporting part 111b protruding from the receiving part 111a and extending toward the inner periphery of the base body 111, and supporting the gasket 90 received in the receiving part 111a in the direction crossing the main face of the separating membrane 80 (the right-left direction of the sheet of FIGS. 25B to 25D, which may be hereinafter referred to as “stacking direction”) (FIG. 25D).

FIG. 25C is a cross-sectional view showing the position where the gasket 90 is received in the receiving part 111a of the base body 111 and supported by the supporting part 111b in the direction crossing the main face of the separating membrane 80. The receiving part 111a has a depth more than the thickness of the gasket 90 holding the periphery of the separating membrane 80, in the stacking direction. Thus, when the gasket 90 holding the separating membrane 80 is received in the receiving part 111a and supported by the supporting part 111b in the stacking direction, a step is formed between a face 90a of the gasket 90 received in the receiving part 111a which is on the opposite side of the supporting part 111b, and a face 111c of the base body 111 which is on the opposite side of the supporting part 111b (FIG. 25C). The lid member 112 has dimensions that allow itself to be received in the step between the face 111c of the base body 111 including the receiving part 111a, which receives the gasket 90, and the face 90a of the gasket 90. That is, the periphery of the lid member 112 has approximately the same dimensions as the inner periphery of the receiving part 111a of the base body 111; the inner periphery of the lid member 112 has approximately the same dimensions as the inner periphery of the supporting part 111b of the base body 111; and the thickness of the lid member 112 is set in such a manner that the total of the thickness of the gasket 90 holding the separating membrane 80 and the thickness of the lid member 112 is approximately the same as the depth of the receiving part 111a of the base body 111, in the stacking direction. FIG. 25B is a cross-sectional view showing the position where the lid member 112 is received in the step between the face 111c of the base body 111 and the face 90a of the gasket 90 in FIG. 25C. As shown in FIG. 25B, the gasket 90 and the lid member 112 are received in the receiving part 111a of the base body 111, and thereby, the gasket 90 is sandwiched between and held by the supporting part 111b of the base body 111, and the lid member 112.

An ion-permeable separating membrane that can be used for an electrolysis vessel for alkaline water electrolysis may be used as the separating membrane 80 without particular limitations. The separating membrane 80 desirably has low gas permeability, low electric conductivity, and high strength. Examples of the separating membrane 80 include porous separating membranes such as a porous membrane formed of asbestos and of modified asbestos, a porous separating membrane using a polysulfone-based polymer, a cloth using a polyphenylene sulfide fiber, a fluorinated porous membrane, and a porous membrane using a hybrid material including both inorganic and organic materials. Other than these porous separating membranes, an ion-exchange membrane such as a fluorinated ion-exchange membrane may be used as the separating membrane 80.

A gasket that can be used for an electrolysis vessel for alkaline water electrolysis may be used as the gasket 90 without particular limitations. FIGS. 25B to 25D show a cross section of the gasket 90. The gasket 90 has a flat shape, holds the periphery of the separating membrane 80, and is sandwiched between and held by the supporting part 111b of the base body 111, and the lid member 112, in the receiving part 111a of the base body 111. The gasket 90 is preferably formed of an alkali-resistant elastomer. Examples of the material of the gasket 90 include elastomers such as natural rubber (NR), styrene-butadiene rubber (SBR), polychloroprene (CR), butadiene rubber (BR), acrylonitrile-butadiene rubber (NBR), ethylene propylene rubber (EPT), ethylene propylene diene monomer rubber (EPDM), isobutylene isoprene rubber (IIR), and chlorosulfonated polyethylene rubber (CSM). When a gasket material that is not alkali-resistant is used, a layer of an alkali-resistant material may be provided over the surface of the gasket material by coating or the like.

Preferably, the base body 111 is electrically insulating against voltage application from the outside. In one embodiment, the base body 111 is formed of an electrically insulating material. An alkali-resistant resin material having strength with which a pressing force applied in the stacking direction is withstood may be preferably used as the electrically insulating material forming the base body 111. Preferred examples of such a resin material include rigid polyvinyl chloride resins, polypropylene resins, polyethylene resins, polyetherimide resins, polyphenylenesulfide resins, polybenzimidazole resins, polytetrafluoroethylene resins, tetrafluoroethylene-perfluoroalkyl vinyl ether copolymer resins, and tetrafluoroethylene-ethylene copolymer resins. In another embodiment, the base body 111 includes a core made from a metallic material, and a coating layer of an electrically insulating material with which the surface of the core is coated. Examples of the metallic material forming the core of the base body 111 include rigid metallic materials such as simple metals including iron, and stainless steel including SUS304. Preferred examples of the electrically insulating material forming the coating layer of the base body 111 include the above described electrically insulating resin materials, and electrically insulating and alkali-resistant elastomers. Preferred examples of such an elastomer include natural rubber (NR), styrene-butadiene rubber (SBR), polychloroprene (CR), butadiene rubber (BR), acrylonitrile-butadiene rubber (NBR), ethylene propylene rubber (EPT), ethylene propylene diene monomer rubber (EPDM), isobutylene isoprene rubber (IIR), and chlorosulfonated polyethylene rubber (CSM). When an elastomer that is not alkali-resistant is used, a layer of an alkali-resistant material may be provided over the surface of this elastomer by coating or the like.

The lid member 112 may be made from a metal, or may be formed of an electrically insulating material. Examples of the metallic material forming the lid member 112 include the metallic materials same as those described above concerning the base body 111. In one embodiment, the lid member 112 is formed of an electrically insulating material. Preferred examples of the electrically insulating material forming the lid member 112 include the resin materials same as those described above concerning the base body 111. In another embodiment, the lid member 112 includes a core made from a metallic material, and a coating layer of an electrically insulating material with which the surface of the core is coated. Examples of the metallic material forming the core of the lid member 112 include the rigid metallic materials same as those described above concerning the core of the base body 111. Preferred examples of the electrically insulating material forming the coating layer of the lid member 112 include the resin materials and elastomers same as those described above concerning the coating layer of the base body 111.

In the electrolysis vessel 10000, anode chambers (A1, A2, A3) each including the anode 920 arranged therein are each defined among the first faces 10a of the separating walls 10 of the electrolysis elements 900, and the separating membranes 80 facing these first faces 10a; and between the first separating wall 1310 of the first terminal element 1300, and the separating membrane 80 facing the first separating wall 1310. In addition, cathode chambers (C1, C2, C3) each including the cathode 30 arranged therein are each defined among the second faces 10b of the separating walls 10 of the electrolysis elements 900, and the separating membranes 80 facing these second faces 10b; and between the second separating wall 1410 of the second terminal element 1400, and the separating membrane 80 facing the second separating wall 1410. The first terminal element 1300 defines the anode chamber (A1) only, and an anode terminal is connected to the first separating wall 1310 thereof. This anode terminal is connected to a cathode of a DC power supply. The second terminal element 1400 defines the cathode chamber (C3) only, and a cathode terminal is connected to the second separating wall 1410 thereof. This cathode terminal is connected to an anode of the DC power supply. The electrolysis vessel 10000 further comprises: an anolyte supply flow path (not shown) adapted to supply an anolyte to each of the anode chambers (A1, A2, A3); an anolyte and gas collection flow path (not shown) adapted to collect the anolyte and gas from each of the anode chambers; a catholyte supply flow path (not shown) adapted to supply a catholyte to each of the cathode chambers (C1, C2, C3); and a catholyte and gas collection flow path (not shown) adapted to collect the catholyte and gas from each of the cathode chambers.

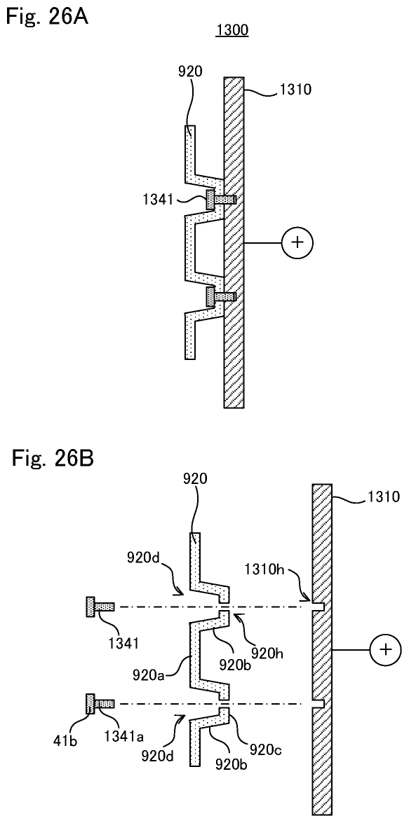

FIG. 26A is a cross-sectional view schematically illustrating the first terminal element 1300, and corresponds to FIG. 17A. In FIGS. 26A and 26B, the elements already shown in FIGS. 2A to 25D are given the same reference signs as in FIGS. 2A to 25D, and the description thereof may be omitted. FIG. 26B is an exploded cross-sectional view schematically illustrating the position where the union of the anode 920 and the first separating wall 1310 is dissolved in FIG. 26A, and corresponds to FIG. 17B. The first terminal element 1310 comprises: the electroconductive first separating wall 1310; the anode 920 electrically connected to the first separating wall 1310; and electroconductive first bolts 1341 with which the anode 920 is fixed to the separating wall 1310.

The first separating wall 1310 is different from the separating wall 10 in comprising threaded holes 1310h that can engage with the first bolts 1341, instead of the first through-holes 10h. As the material of the first separating wall 1310, the electroconductive material same as the material of the above-described separating wall 10 may be used, and a preferred mode of the first separating wall 1310 is also the same as described above. The first bolts 1341 are different from the bolts 41 in comprising shorter shafts 1341a instead of the shafts 41a. As the material of the first bolts 1341, the electroconductive material same as the material of the above-described bolts 41 may be used, and a preferred mode of the first bolts 1341 is also the same as described above. The length of each of the shafts 1341a is preferably shorter than the total of the thickness of the bottom portion 920c of each of the first cup-shaped portions 920b of the anode 920 and the depth of each of the threaded holes 1310h. In the first terminal element 1300, the shafts 1341a of the first bolts 1341 are put through the fifth through-holes 920h provided in the bottom portions 920c of the first cup-shaped portions 920b of the anode 920, to engage with the threaded holes 1310h of the first separating wall 1310, and thereby, the anode 920 is screwed to the first separating wall 1310 with the first bolts 1341, and the anode 920 is electrically connected to the first separating wall 1310.

As shown in FIG. 24, the second terminal element 1400 comprises the electroconductive second separating wall 1410, electroconductive ribs 1470 protruding from the second separating wall 1410, the cathode current collector 660 held by the electroconductive ribs 1470 (see FIGS. 14A and 14B), the electroconductive elastic body 50 supported by the cathode current collector 660, and the cathode 30 supported by the elastic body 50.

Known electroconductive ribs used for an alkaline water electrolysis vessel may be used as the electroconductive ribs 1470 without particular limitations. In the second terminal element 1400, the electroconductive ribs 1470 protrude from the second separating wall 1410. The connecting way, the shape, the number, and the arrangement of the electroconductive ribs 1470 are not particularly limited as long as the cathode current collector 660 can be fixed to and held with respect to the second separating wall 1410 by the electroconductive ribs 1470. As the material of the electroconductive ribs 1470, an alkali-resistant rigid electroconductive material may be used without particular limitations, and for example, a metallic material such as simple metals including nickel and iron, and stainless steel including SUS304, SUS310, SUS310S, SUS316 and SUS316L may be preferably used. These metallic materials may be nickeled for improving corrosion resistance and electroconductivity.

The sealing members 120 are each held between the frame-shaped protecting members 110, and the respective separating walls 10, 1310 and 1410. The sealing members 120 each receive a pressing force between the protecting members 110 and the separating wall 10, 1310 or 1410, and thereby, prevents the electrolyte or gas from leaking out between the protecting members 110 and the separating walls 10, 1310 and 1410 due to the internal pressure of each chamber. The sealing members 120 are preferably formed of an alkali-resistant elastomer. Examples of the material of the sealing members 120 include elastomers such as natural rubber (NR), styrene-butadiene rubber (SBR), polychloroprene (CR), butadiene rubber (BR), acrylonitrile-butadiene rubber (NBR), ethylene propylene rubber (EPT), ethylene propylene diene monomer rubber (EPDM), isobutylene isoprene rubber (IIR), and chlorosulfonated polyethylene rubber (CSM). When an elastomer that is not alkali-resistant is used for the sealing members 120, a layer of an alkali-resistant material may be provided over the surface of a core including such an elastomer by coating or the like. The sealing members 120 may be flat gaskets, but are preferably O-rings. The use of O-rings as the sealing members can further improve the pressure resistance of the electrolysis vessel 10000.

The electrolysis vessel 10000 comprises the electrolysis element 900 according to the present invention as an electrolysis element, which thus allows easy work of replacing the anode 920, and therefore, can reduce time and cost required for renewal of the anode 920. In the first terminal element 1300, the anode 920 is fixed to the first separating wall 1310 by screwing with the first bolts 1341. This also allows easy work of replacing the anode 920 in the first terminal element 1300.

The electrolysis vessel 10000 comprising the electrolysis elements 900 has been described above concerning the present invention as an example. The present invention is not limited to this embodiment. For example, the electrolysis vessel may comprise the above-described other electrolysis element 100 (FIGS. 2A and 2B), 200 (FIGS. 4A and 4B), 300 (FIGS. 7A and 7B), 400 (FIGS. 8A and 8B), 500 (FIGS. 12A and 12B), 600 (FIGS. 14A and 14B), 700 (FIGS. 15A and 15B), 800 (FIGS. 16A and 16B), 1000 (FIGS. 20A and 20B) or 1100 (FIGS. 21A and 21B) instead of the electrolysis element 900.

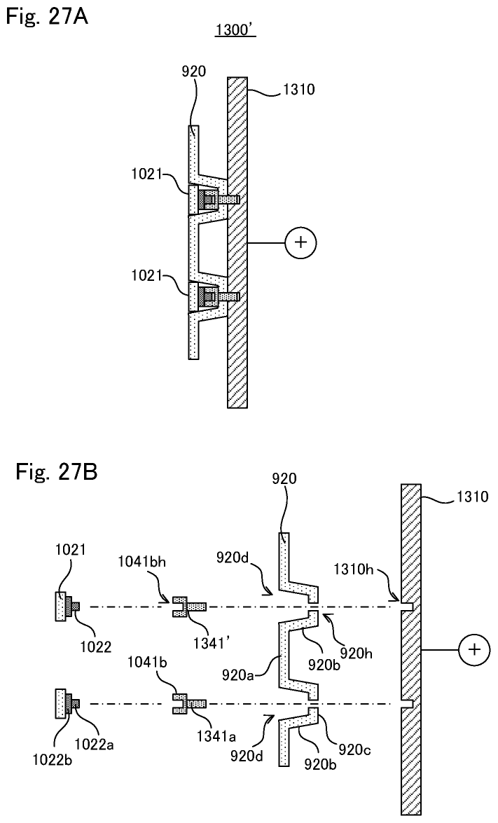

The electrolysis vessel 10000 comprising the first terminal element 1300 wherein the openings 920d of the first cup-shaped portions 920b of the anode 920 are not covered has been described above concerning the present invention as an example. The present invention is not limited to this embodiment. For example, the electrolysis vessel may comprise a first terminal element including lid members covering at least part of the respective openings 920d of the first cup-shaped portions 920b of the anode 920. FIG. 27A is a cross-sectional view schematically illustrating a first terminal element 1300′ according to such another embodiment, and corresponds to FIGS. 26A and 20A. The first terminal element 1300′ is further different from the first terminal element 1300 (FIGS. 26A and 26B) in further comprising the removable second lid members 1021, 1021, . . . comprising the same material as the anode 920 and covering at least part of respective openings 920d of the first cup-shaped portions 920b, 920b, . . . of the anode 920 (see FIGS. 20A and 20B), and the electroconductive second bolts 1022 fixed to the respective second lid members 1021 (see FIGS. 20A and 20B); and comprising first bolts 1341′, 1341, . . . (hereinafter may be simply referred to as “first bolts 1341′”) instead of the first bolts 1341, 1341, . . . . The first bolts 1341′ are different from the first bolts 1341 in comprising the heads 1041b (see FIGS. 20A and 20B) instead of the heads 41b. FIG. 27B is an exploded cross-sectional view schematically illustrating the position of the first terminal element 1300′ in FIG. 27A, where the union of the anode 920 and the separating wall 1310 is dissolved, and where the lid members 1021 are removed from the openings 920d of the first cup-shaped portions 920b, and corresponds to FIGS. 26B and 20B.

In the first terminal element 1300′, (the shafts 1022a of) the second bolts 1022 fixed to the second lid members 1021 are engaged with the threaded holes 1041bh provided in the heads 1041b of the first bolts 1341′, and thereby, the second lid members 1021 are removably fixed to the first bolts 1341′, electrically connected to the first bolts 1341′ via the second bolts 1022, and cover at least part of the respective openings 920d of the first cup-shaped portions 920b of the anode 920. This causes the second lid members 1021 to be electrically connected to the anode 920 via the second bolts 1022 and the first bolts 1341′.

The same effect as obtained from the above-described electrolysis vessel 10000 (FIG. 23) can be also obtained from the electrolysis vessel using such a first terminal element 1300′. Further, according to the electrolysis vessel comprising the first terminal element 1300′ including the second lid members 1021, the second lid members 1021 compensate for the area of the anode, which is reduced by the openings 920d of the first cup-shaped portions 920b in the first terminal element 1300′, which thus can ensure more uniformity of the current distribution, to further reduce energy loss.

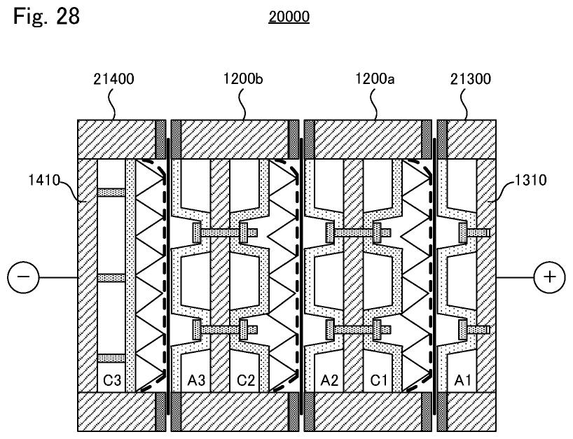

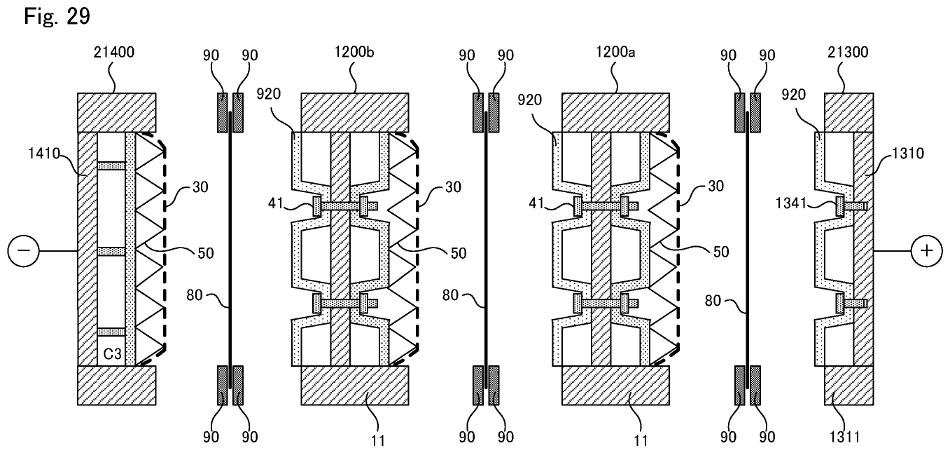

The electrolysis vessel 10000 comprising the electrolysis element 900 provided with no flange portion at the periphery of the separating wall 10 has been described above concerning the present invention as an example. The present invention is not limited to this embodiment. For example, the electrolysis vessel may comprise an electrolysis element provided with a flange portion at the periphery of the separating wall 10. FIG. 28 is a cross-sectional view schematically illustrating an alkaline water electrolysis vessel 20000 according to such another embodiment (hereinafter may be simply referred to as “electrolysis vessel 20000”). FIG. 29 is an exploded view of FIG. 28. In FIGS. 28 and 29, the elements already shown in FIGS. 2A to 27B are given the same reference signs as in FIGS. 2A to 27B, and the description thereof may be omitted. The electrolysis vessel 20000 comprises a stack structure comprising: a plurality of ion-permeable separating membranes 80, 80, . . . ; and the electrolysis elements 1200, 1200, . . . each arranged between each adjacent pair of the separating membranes 80, 80 (FIGS. 22A and 22B). Each adjacent pair of the electrolysis elements 1200, 1200 is arranged so that the anode 920 of one of the electrolysis elements 1200 and the cathode 30 of the other electrolysis element 1200 face each other sandwiching the separating membrane 80 therebetween. The electrolysis vessel 20000 further comprises a first terminal element 21300 and a second terminal element 21400. The first terminal element 21300 is arranged facing the cathode 30 of a first electrolysis element 1200a arranged at one end of the stack structure, such that the first terminal element 21300 and the cathode 30 of the first electrolysis element 1200a sandwich the separating membrane 80 therebetween. The second terminal element 21400 is arranged facing the anode 920 of a second electrolysis element 1200b arranged at the other end of the stack structure, such that the second terminal element 21400 and the anode 920 of the second electrolysis element 1200b sandwich the separating membrane 80 therebetween. The first terminal element 21300 comprises: the electroconductive first separating wall 1310; and the first anode 920 electrically connected to the first separating wall 1310. The second terminal element 21400 comprises: the electroconductive second separating wall 1410; and the second cathode 30 electrically connected to the second separating wall 1410.

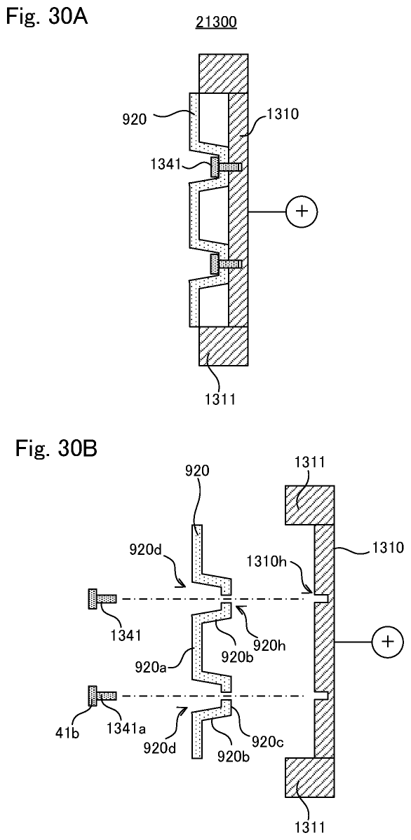

FIG. 30A is a cross-sectional view schematically illustrating the first terminal element 21300, and corresponds to FIG. 26A. In FIGS. 30A and 30B, the elements already shown in FIGS. 2A to 29 are given the same reference signs as in FIGS. 2A to 29, and the description thereof may be omitted. FIG. 30B is an exploded cross-sectional view schematically illustrating the position where the union of the anode 920 and the first separating wall 1310 is dissolved in FIG. 30A, and corresponds to FIG. 26B. The first terminal element 21300 is different from the first terminal element 1300 (FIGS. 24, 26A and 26B) in further comprising a first flange portion 1311 being arranged at the periphery of the first electroconductive separating wall 1310 and extending toward the flange portion 11 of the first electrolysis element 1200a.

In the first terminal element 21300, the flange portion 1311 unites with the periphery of the first separating wall 1310 with watertightness. An alkali-resistant rigid material may be used as the material of the flange portion 1311 without particular limitations. Examples of such a material include simple metals such as nickel and iron; stainless steel such as SUS304, SUS310, SUS310S, SUS316 and SUS316L; metal materials obtained by nickeling any of them; and non-metal materials such as reinforced plastics. The separating wall 1310 and the flange portion 1311 may be joined to each other by welding, adhesion, or the like, and may be formed of the same material into one body.

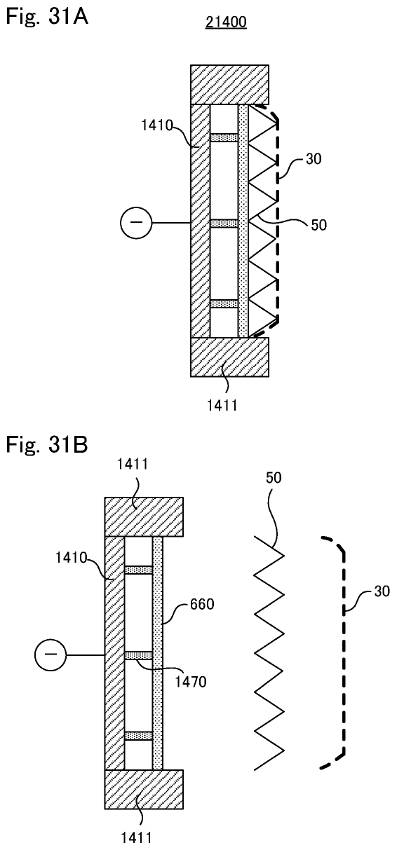

FIG. 31A is a cross-sectional view schematically illustrating the second terminal element 21400. In FIGS. 31A and 31B, the elements already shown in FIGS. 2A to 30B are given the same reference signs as in FIGS. 2A to 30B, and the description thereof may be omitted. FIG. 31B is an exploded cross-sectional view schematically illustrating the position where the cathode 30 and the elastic body 50 are removed in the second terminal element 21400 in FIG. 31A. The second terminal element 21400 is different from the second terminal element 1400 (FIG. 24) in further comprising a second flange portion 1411 being arranged at the periphery of the second electroconductive separating wall 1410 and extending toward the flange portion 11 of the second electrolysis element 1200b.

In the second terminal element 21400, the flange portion 1411 unites with the periphery of the second separating wall 1410 with watertightness. An alkali-resistant rigid material may be used as the material of the flange portion 1411 without particular limitations. Examples of such a material include simple metals such as nickel and iron; stainless steel such as SUS304, SUS310, SUS310S, SUS316 and SUS316L; metal materials obtained by nickeling any of them; and non-metal materials such as reinforced plastics. The separating wall 1410 and the flange portion 1411 may be joined to each other by welding, adhesion, or the like, and may be formed of the same material into one body.

In the electrolysis vessel 20000, the periphery of each of the separating membranes 80 is held by the gaskets 90, 90, and the separating membranes 80 are each sandwiched between and held by every two adjacent flange portions (that is, each pair of two adjacent flange portions among the flange portions 11 of the electrolysis elements 1200, the flange portion 1311 of the first terminal element 21300, and the flange portion 1411 of the second terminal element 21400) by means of the gaskets 90. In the electrolysis vessel 20000, anode chambers (A1, A2, A3) each including the anode 920 arranged therein are each defined among the first faces 10a of the separating walls 10 of the electrolysis elements 1200, and the separating membranes 80 facing these first faces 10a; and between the first separating wall 1310 of the first terminal element 21300, and the separating membrane 80 facing the first separating wall 1310. In addition, cathode chambers (C1, C2, C3) each including the cathode 30 arranged therein are each defined among the second faces 10b of the separating walls 10 of the electrolysis elements 1200, and the separating membranes 80 facing these second faces 10b; and between the second separating wall 1410 of the second terminal element 21400, and the separating membrane 80 facing the second separating wall 1410. The first terminal element 21300 defines the anode chamber (A1) only, and an anode terminal is connected to the first separating wall 1310 thereof. This anode terminal is connected to a cathode of a DC power supply. The second terminal element 21400 defines the cathode chamber (C3) only, and a cathode terminal is connected to the second separating wall 1410 thereof. This cathode terminal is connected to an anode of the DC power supply. In the electrolysis vessel 20000, the flange portion 11 of each of the electrolysis elements 1200 is provided with the anolyte supply flow path (not shown) adapted to supply the anolyte to each of the anode chambers (A1, A2, A3); the anolyte and gas collection flow path (not shown) adapted to collect the anolyte and gas from each of the anode chambers; the catholyte supply flow path (not shown) adapted to supply the catholyte to each of the cathode chambers (C1, C2, C3); and the catholyte and gas collection flow path (not shown) adapted to collect the catholyte and gas from each of the cathode chambers. The flange portion 1311 of the first terminal element 21300 is provided with an anolyte supply flow path and an anolyte and gas collection flow path. The flange portion 1411 of the second terminal element 21400 is provided with a catholyte supply flow path and a catholyte and gas collection flow path. The flange portion 1311 of the first terminal element 21300 may be further provided with a catholyte supply flow path, and a catholyte and gas collection flow path. These catholyte supply flow path, and catholyte and gas collection flow path however do not connect to the anode chamber A1 defined by the first terminal element 23100. The flange portion 1411 of the second terminal element 21400 may be further provided with an anolyte supply flow path, and an anolyte and gas collection flow path. These anolyte supply flow path and anolyte, and gas collection flow path however do not connect to the cathode chamber C3 defined by the second terminal element.

The electrolysis vessel 20000 comprises the electrolysis element 1200 according to the present invention as an electrolysis element, which thus allows easy work of replacing the anode 920, and therefore, can reduce time and cost required for renewal of the anode 920. In the first terminal element 21300, the anode 920 is fixed to the first separating wall 1310 by screwing with the first bolts 1341. This also allows easy work of replacing the anode 920 in the first terminal element 21300.

The electrolysis vessel 20000 comprising the electrolysis element 1200 has been described above concerning the present invention as an example. The present invention is not limited to this embodiment. For example, the electrolysis vessel may comprise an electrolysis element including the flange portion at the periphery of the separating wall of the above-described other electrolysis element 100 (FIGS. 2A and 2B), 200 (FIGS. 4A and 4B), 300 (FIGS. 7A and 7B), 400 (FIGS. 8A and 8B), 500 (FIGS. 12A and 12B), 600 (FIGS. 14A and 14B), 700 (FIGS. 15A and 15B), 800 (FIGS. 16A and 16B), 1000 (FIGS. 20A and 20B) or 1100 (FIGS. 21A and 21B) instead of the electrolysis element 1200.

The electrolysis vessel 20000 comprising the first terminal element 21300 wherein the openings 920d of the first cup-shaped portions 920b of the anode 920 are not covered has been described above concerning the present invention as an example. The present invention is not limited to this embodiment. For example, the electrolysis vessel may comprise a first terminal element including lid members covering at least part of the respective openings 920d of the first cup-shaped portions 920b of the anode 920. As such a first terminal element, for example, a first terminal element comprising the flange portion 1311 (see FIGS. 30A and 30B) at the periphery of the first separating wall 1310 of the above-described first terminal element 1300′ (see FIGS. 27A and 27B) may be used.

### REFERENCE SIGNS LIST

100, 200, 300, 400, 500, 600, 700, 800, 900, 1000, 1100, 1200 electrolysis element
10, 610 separating wall
10a first face
10b second face
11, 1311, 1411 flange portion
20, 620, 920 anode
620h fourth through-hole
721, 1021 second lid member
722, 1022 second bolt
722a extension shaft
722b lid member fixing screw
1022a shaft
1022b head
920a first flat portion
920b first cup-shaped portion
920c bottom portion (of the first cup-shaped portion)
920d opening (of the first cup-shaped portion)
920h fifth through-hole
30 cathode
40, 340, 440, 540, 640, 740 first connecting means
41, 341, 641, 741, 841 first bolt
41a, 341a, 641a shaft
841e1 first end (of a stud bolt)
841e2 second end (of the stud bolt)
341h bolt end threaded hole
41b, 741b head
741bh, 841h second threaded hole
1041bh (bolt head) threaded hole
10h first through-hole
610h first threaded hole
42, 842 first nut
43, 443 first structural element
43a first spacer portion
43ae end
43b first plate-shaped portion
43bh second through-hole
44, 1144 second nut
50 elastic body
60, 660, 960 cathode current collector
60h third through-hole
61, 361 first lid member
61a flat surface part
61w wire part
361b extension shaft
361c lid member fixing screw
960a second flat portion
960b second cup-shaped portion
960c bottom portion (of the second cup-shaped portion)
960d opening (of the second cup-shaped portion)
960h sixth through-hole
70 second connecting means
71 second structural element
71a second spacer portion
71ec end
71ew end
940 third connecting means
941 first bolt
941a shaft
941b head
942 first nut
80 (ion-permeable) separating membrane
90 gasket
110 frame-shaped protecting member
120 sealing member
1300 first terminal element
1310 first separating wall
1400 second terminal element
1410 second separating wall
d1 first distance
d2 second distance
10000, 20000 alkaline water electrolysis vessel
9000 conventional zero-gap alkaline water electrolysis vessel
9010 chamber unit
9011 electroconductive separating wall
9012 flange portion
9013, 9014 electroconductive rib
9020 ion-permeable separating membrane
9030 gasket
9040 anode
9050 current collector
9060 electroconductive elastic body
9070 cathode
A, A1, A2, A3 anode chamber
C, C1, C2, C3 cathode chamber

1. An electrolysis element for alkaline water electrolysis, the electrolysis element comprising:
an electroconductive separating wall comprising a first face and a second face;
an anode for generating oxygen;
a cathode for generating hydrogen;
a first connecting means fixing the anode to the separating wall such that the anode faces the first face of the separating wall at a first distance, and electrically connecting the anode to the separating wall;
an electroconductive elastic body supporting the cathode; and
a cathode current collector supporting the elastic body,
the cathode current collector being fixed to the separating wall, to face the second face of the separating wall at a second distance, and being electrically connected to the separating wall,
the first connecting means comprising:
an electroconductive first bolt comprising at least a shaft,
wherein the anode is removably fixed to the separating wall by means of the first bolt.

2. The electrolysis element according to claim 1,
the first connecting means further comprising:
a first through-hole provided in the separating wall, wherein the shaft of the first bolt can be put through the first through-hole; and
a first nut which can engage with the first bolt.

3. The electrolysis element according to claim 2,
the first connecting means further comprising:
an electroconductive first structural element,
the first structural element comprising:
a first spacer portion extending from the anode toward the first face of the separating wall in a direction crossing the first face of the separating wall; and
a first plate-shaped portion being continuous from the first spacer portion and extending in a direction parallel to the first face of the separating wall,
the first spacer portion comprising:
an end fixed to the anode,
the first plate-shaped portion comprising:
a second through-hole, wherein the shaft of the first bolt can be put through the second through hole,
wherein the shaft of the first bolt is put through the first through-hole and the second through-hole and engages with the first nut, to fix the first structural element to the separating wall.

4. The electrolysis element according to claim 3,
wherein the second through-hole is continuous from the first plate-shaped portion to at least part of the first spacer portion.

5. The electrolysis element according to claim 3,
the first bolt further comprising:
a head arranged at an end of the shaft,
the shaft of the first bolt being put through the first through-hole and the second through-hole, in a direction such that the head of the first bolt pushes the first plate-shaped portion of the first structural element toward the separating wall,
the first structural element further comprising:
a rotation-limiting portion, wherein when the shaft of the first bolt is put through the second through-hole and the head of the first bolt contacts with the first plate-shaped portion, the rotation-limiting portion contacts with a side surface of the head of the first bolt, to limit rotation of the first bolt.

6. The electrolysis element according to any one of claim 3,
the first connecting means further comprising:
a second nut which can engage with the first bolt,
wherein the second nut engages with the shaft of the first bolt put through the second through-hole, such that the head of the first bolt and the second nut sandwich the first plate-shaped portion of the first structural element, to fix the first bolt to the first plate-shaped portion of the first structural element; and
the shaft of the first bolt fixed to the first plate-shaped portion of the first structural element is put through the first through-hole of the separating wall and engages with the first nut, to fix the first bolt to the separating wall.

7. The electrolysis element according to claim 3,
the cathode current collector comprising:
a third through-hole provided in a position facing the first through-hole of the separating wall, the third through-hole having a shape and dimensions such that the first nut can pass through the third through-hole.

8. The electrolysis element according to claim 7, further comprising:
an electroconductive and removable first lid member covering at least part of the third through-hole of the cathode current collector,
wherein when the first lid member is put to cover at least part of the third through-hole of the cathode current collector, the first lid member is electrically connected to the cathode current collector.

9. The electrolysis element according to claim 1,
the first connecting means further comprising:
a first threaded hole opening in the first face of the separating wall, wherein the first threaded hole can engage with the first bolt.

10. The electrolysis element according to claim 9,
the first connecting means further comprising:
an electroconductive first structural element,
the first structural element comprising:
a first spacer portion extending from the anode toward the first face of the separating wall in a direction crossing the first face of the separating wall; and
a first plate-shaped portion being continuous from the first spacer portion and extending in a direction parallel to the first face of the separating wall,
the first spacer portion comprising:
an end fixed to the anode,
the first plate-shaped portion comprising:
a second through-hole, wherein the shaft of the first bolt can be put through the second through-hole,
wherein the shaft of the first bolt is put through the second through-hole and engages with the first threaded hole of the separating wall, to fix the first structural element to the separating wall.

11. The electrolysis element according to claim 10,
the anode comprising:
a fourth through-hole provided in a position facing the second through-hole, the fourth through-hole having a shape and dimensions such that the first bolt can pass through the fourth through-hole.

12. The electrolysis element according to claim 11, further comprising:
a second lid member comprising a same material as the anode and covering at least part of the fourth through-hole of the anode; and
an electroconductive second bolt fixed to the second lid member,
the first bolt further comprising a head,
the head of the first bolt comprising:
a second threaded hole which can engage with the second bolt,
wherein the second bolt engages with the second threaded hole, such that the second lid member is removably fixed to the first bolt and is electrically connected to the first bolt and such that the second lid member covers at least part of the fourth through-hole of the anode.

13. The electrolysis element according to claim 9,
the first bolt being a stud bolt,
the stud bolt comprising:
a first end; and
a second end,
the first connecting means further comprising:
an electroconductive first structural element; and
a first nut which can engage with the stud bolt,
the first structural element comprising:
a first spacer portion extending from the anode toward the first face of the separating wall in a direction crossing the first face of the separating wall; and
a first plate-shaped portion being continuous from the first spacer portion and extending in a direction parallel to the first face of the separating wall,
the first spacer portion comprising:
an end fixed to the anode,
the first plate-shaped portion comprising:
a second thorough-hole, wherein the first bolt can be put through the second through-hole,
wherein the stud bolt engages with the first threaded hole of the separating wall, to fix the first end of the stud bolt to the separating wall; and
the stud bolt fixed to the separating wall is put through the second through-hole, and the first nut engages with the stud bolt from the second end of the stud bolt, to fix the first structural element to the separating wall.

14. The electrolysis element according to claim 13,
the anode comprising:
a fourth through-hole provided in a position facing the second through-hole, the fourth through-hole having a shape and dimensions such that the first nut can pass through the fourth through-hole.

15. The electrolysis element according to claim 14, further comprising:
a second lid member comprising a same material as the anode and covering at least part of the fourth through-hole of the anode; and
an electroconductive second bolt fixed to the second lid member,
the second end of the stud bolt comprising:
a second threaded hole which can engage with the second bolt,
wherein the second bolt engages with the second threaded hole, such that the second lid member is removably fixed to the stud bolt and is electrically connected to the stud bolt, and such that the second lid member covers at least part of the fourth through-hole of the anode.

16. The electrolysis element according to claim 1, further comprising:
a second connecting means fixing the cathode current collector to the separating wall such that the cathode current collector faces the second face of the separating wall at the second distance, and electrically connecting the cathode current collector to the separating wall,
the second connecting means comprising:
an electroconductive second structural element,
the second structural element comprising:
a second spacer portion extending between the cathode current collector and the second face of the separating wall in a direction crossing the second face of the separating wall;
a first end fixed to the cathode current collector; and
a second end fixed to the second face of the separating wall.

17. An electrolysis element for alkaline water electrolysis, the electrolysis element comprising:
a separating wall comprising a first face and a second face;
an anode for generating oxygen;
a cathode for generating hydrogen;
an electroconductive elastic body supporting the cathode;
a cathode current collector supporting the elastic body; and
a third connecting means fixing the anode and the cathode current collector to the separating wall and electrically connecting the anode and the cathode current collector, such that the anode faces the first face of the separating wall and the cathode current collector faces the second face of the separating wall,
the third connecting means comprising:
an electroconductive first bolt comprising at least a shaft;
a first through-hole provided in the separating wall, wherein the shaft of the first bolt can put through the first through-hole; and
a first nut which can engage with the first bolt,
the anode comprising:
a first flat portion extending two-dimensionally;
a first cup-shaped portion protruding from the first flat portion toward the first face of the separating wall and being tapered; and
a fifth through-hole provided in a bottom portion of the first cup-shaped portion, wherein the shaft of the first bolt can be put through the fifth through-hole,
the cathode current collector comprising:
a second flat portion extending two-dimensionally;
a second cup-shaped portion protruding from the second flat portion toward the second face of the separating wall and being tapered;
a sixth through-hole provided in a bottom portion of the second cup-shaped portion, wherein the shaft of the first bolt can be put through the sixth through-hole,
wherein the shaft of the first bolt is put through the first through hole, the fifth through-hole, and the sixth through-hole, and engages with the first nut, to fix the anode and the cathode current collector to the separating wall by means of the first bolt.

18. The electrolysis element according to claim 17,
the first bolt further comprising:
a head arranged at an end of the shaft,
wherein the head of the first bolt and the first nut sandwich and fasten the anode, the separating wall, and the cathode current collector.

19. The electrolysis element according to claim 18, further comprising:
a second lid member comprising a same material as the anode, and having a shape extending two-dimensionally such that the second lid member can cover at least part of an opening of the first cup-shaped portion of the anode; and
an electroconductive second bolt,
the second bolt comprising:
a head fixed to the second lid member; and
a shaft fixed to the head,
the head of the first bolt comprising:
a threaded hole which can engage with the second bolt,
wherein the second bolt engages with the threaded hole, such that the second lid member is removably fixed to the first bolt and is electrically connected to the first bolt and covers at least part of the opening of the first cup-shaped portion of the anode.

20. The electrolysis element according to claim 17, further comprising:
a second lid member comprising a same material as the anode and having a shape extending two-dimensionally such that the second lid member can cover at least part of an opening of the first cup-shaped portion of the anode,
the first bolt further comprising:
a head arranged at an end of the shaft,
the second lid member being fixed to the head of the first bolt and being electrically connected to the first bolt,
the third connecting means further comprising:
a second nut which can engage with the first bolt,
wherein the shaft of the first bolt is put through the first through-hole, the fifth through-hole, and the sixth through-hole, and engages with the first nut and the second nut, such that the first nut and the second nut sandwich and fasten the anode, the separating wall, and the cathode current collector, and such that the anode, the second lid member, and the cathode current collector are removably fixed to the separating wall by means of the first bolt, and such that the second lid member covers at least part of the opening of the first cup-shaped part of the anode.

21. (canceled)

22. An alkaline water electrolysis vessel comprising a stack structure,
the stack structure comprising:
a plurality of ion-permeable separating membrane;
the electrolysis element as defined in claim 1, arranged between each adjacent pair of the ion-permeable separating membranes,
wherein each adjacent pair of the electrolysis elements is arranged so that the anode of a first one of the electrolysis elements of the pair and the cathode of a second one of the electrolysis elements of the pair face each other sandwiching the ion-permeable separating membrane therebetween.

23-25. (canceled)

26. An alkaline water electrolysis vessel comprising a stack structure,
the stack structure comprising:
a plurality of ion-permeable separating membrane;
the electrolysis element as defined in claim 17, arranged between each adjacent pair of the ion-permeable separating membranes,
wherein each adjacent pair of the electrolysis elements is arranged so that the anode of a first one of the electrolysis elements of the pair and the cathode of a second one of the electrolysis elements of the pair face each other sandwiching the ion-permeable separating membrane therebetween.
